(19) United States
(12) Patent Application Publication
(10) Pub. No.: US 2011/0037833 A1
(43) Pub. Date: Feb. 17, 2011

(54) METHOD AND APPARATUS FOR PROCESSING SIGNAL FOR THREE-DIMENSIONAL REPRODUCTION OF ADDITIONAL DATA

(75) Inventors: Dae-jong LEE, Suwon-si (KR); Bong-gil BAK, Suwon-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/857,724

(22) Filed: Aug. 17, 2010

Related U.S. Application Data
(60) Provisional application No. 61/320,389, filed on Apr. 2, 2010.
(60) Provisional application No. 61/242,117, filed on Sep. 14, 2009.
(60) Provisional application No. 61/234,352, filed on Aug. 17, 2009.

(30) Foreign Application Priority Data
Jun. 11, 2010 (KR) 10-2010-0055469

(51) Int. Cl. H04N 13/04

(52) U.S. Cl. 348/46; 348/E13.075

(57) ABSTRACT

A method and apparatus for processing a signal, including: extracting three-dimensional (3D) reproduction information for reproducing a subtitle, which is reproduced with a video image, in 3D, from additional data for generating the subtitle; and reproducing the subtitle in 3D by using the additional data and the 3D reproduction information.

### CROSS-REFERENCE TO RELATED APPLICATIONS

This application claims the benefit of U.S. Provisional Patent Application No. 61/234,352, filed on Aug. 17, 2009, U.S. Provisional Patent Application No. 61/242,117, filed on Sep. 14, 2009, and U.S. Provisional Patent Application No. 61/320,389, filed on Apr. 2, 2010, in the US Patent and Trademark Office, and Korean Patent Application No. 10-2010-0055469, filed on Jun. 11, 2010, in the Korean Intellectual Property Office, the entire disclosure of each of which is incorporated herein by reference for all purposes.

### BACKGROUND

1. Field

The following description relates to a method and apparatus for processing a signal to reproduce additional data that is reproduced with a video image, in three dimensions (3D).

2. Description of the Related Art

Due to developments in digital technologies, a technology for three-dimensionally reproducing a video image has become more widespread. Since human eyes are separated in a horizontal direction by a predetermined distance, two-dimensional (2D) images respectively viewed by the left eye and the right eye are different from each other and thus parallax occurs. The human brain combines the different 2D images, that is, a left-eye image and a right-eye image, and thus generates a three-dimensional (3D) image that looks realistic.

The video image may be displayed with additional data, such as a menu or subtitles, which is additionally provided with respect to the video image. When the video image is reproduced as a 3D video image, a method of processing the additional data that is to be reproduced with the video image needs to be studied.

### SUMMARY

In one general aspect, there is provided a method of processing a signal, the method comprising: extracting three-dimensional (3D) reproduction information for reproducing a subtitle, is the subtitle being reproduced with a video image, in 3D, from additional data for generating the subtitle; and reproducing the subtitle in 3D by using the additional data and the 3D reproduction information.

The method may further include that the 3D reproduction information comprises offset information comprising at least one of: a movement value, a depth value, a disparity, and parallax of a region where the subtitle is displayed.

The method may further include that the 3D reproduction information further comprises an offset direction indicating a direction in which the offset information is applied.

The method may further include that the reproducing of the subtitle in 3D comprises adjusting a location of the region where the subtitle is displayed by using the offset information and the offset direction.

The method may further include that: the additional data comprises text subtitle data; and the extracting of the 3D reproduction information comprises extracting the 3D reproduction information from a dialog presentation segment included in the text subtitle data.

The method may further include that the dialog presentation segment comprises: a number of the regions where the subtitle is displayed; and a number of pieces of offset information equaling the number_of_regions where the subtitle is displayed.

The method may further include that the adjusting of the location comprises: extracting dialog region location information from a dialog style segment included in the text subtitle data; and adjusting the location of the region where the subtitle is displayed by using the dialog region location information, the offset information, and the offset direction.

The method may further include that: the additional data comprises subtitle data; the subtitle data comprises a composition page; the composition page comprises a page composition segment; and the extracting of the 3D reproduction information comprises extracting the 3D reproduction information from the page composition segment.

The method may further include that: the additional data comprises subtitle data; the subtitle data comprises a composition page; the composition page comprises a depth definition segment; and the extracting of the 3D reproduction information comprises extracting the 3D reproduction information from the depth definition segment.

The method may further include that in the 3D reproduction information further comprises information about whether the 3D reproduction information is generated, based on offset information of the video image or based on a screen having zero (0) disparity.

The method may further include that the extracting of the 3D reproduction information comprises extracting at least one of: offset information according to pages and offset information according to regions in a page.

The method may further include that: the additional data comprises a subtitle message; and the extracting of the 3D reproduction information comprises extracting the 3D reproduction information from the subtitle message.

The method may further include that: the subtitle message comprises simple bitmap information; and the extracting of the 3D reproduction information comprises extracting the 3D reproduction information form the simple bitmap information.

The method may further include that the extracting of the 3D reproduction information comprises: extracting the offset information from the simple bitmap information; and extracting the offset direction from the subtitle message.

The method may further include that: the subtitle message further comprises a descriptor defining the 3D reproduction information; and the extracting of the 3D reproduction information comprises extracting the 3D reproduction information from the descriptor included in the subtitle message.

The method may further include that the descriptor comprises: offset information about at least one of: a character and a frame; and the offset direction. The method may further include that: the subtitle message further comprises a subtitle type; and in response to the subtitle type indicating another view subtitle, the subtitle message further comprises information about the other view subtitle.

The method may further include that the information about the other view subtitle comprises frame coordinates of the other view subtitle.

The method may further include that the information about the other view subtitle comprises disparity information of the other view subtitle with respect to a reference view subtitle.

The method may further include that the information about the other view subtitle comprises information about a subtitle bitmap for generating the other view subtitle.

The method may further include that the 3D reproduction information further comprises information about whether the 3D reproduction information is generated based on:

offset information of the video image; or

a screen having zero (0) disparity.

The method may further include that the extracting of the 3D reproduction information comprises extracting at least one of:

offset information according to pages; and

offset information according to regions in a page.

In another general aspect, there is provided an apparatus for processing a signal, the apparatus comprising: a subtitle decoder configured to extract three-dimensional (3D) reproduction information to: reproduce a subtitle, the subtitle being reproduced with a video image, in 3D, from additional data for generating the subtitle; and reproduce the subtitle in 3D by using the additional data and the 3D reproduction information.

The apparatus may further include that the 3D reproduction information comprises offset information comprising at least one of: a movement value, a depth value, a disparity, and parallax of a region where the subtitle is displayed.

The apparatus may further include that the 3D reproduction information further comprises an offset direction indicating a direction in which the offset information is applied.

The apparatus may further include that the subtitle decoder is further configured to adjust a location of the region where the subtitle is displayed by using the offset information and the offset direction.

The apparatus may further include that: the additional data comprises text subtitle data; and the apparatus further comprises a dialog presentation controller configured to extract the 3D reproduction information from a dialog presentation segment included in the text subtitle data.

The apparatus may further include that the dialog presentation segment comprises: a number of the regions where the subtitle is displayed; and a number of pieces of offset information equaling the number_of_regions where the subtitle is displayed.

The apparatus may further include that the dialog presentation controller is further configured to: extract dialog region location information from a dialog style segment included in the text subtitle data; and adjust the location of the region where the subtitle is displayed by using the dialog region location information, the offset information, and the offset direction.

The apparatus may further include that: the additional data comprises subtitle data; the subtitle data comprises a composition page; the composition page comprises a page composition segment; the apparatus further comprises a composition buffer; and the subtitle decoder is further configured to store the 3D reproduction information extracted from the page composition segment in the composition buffer.

The apparatus may further include that: the additional data comprises subtitle data; the subtitle data comprises a composition page; the composition page comprises a depth definition segment; the apparatus further comprises a composition buffer; and the subtitle decoder is further configured to store the 3D reproduction information included in the depth definition segment, in the composition buffer.

The apparatus may further include that the 3D reproduction information further comprises information about whether the 3D reproduction information is generated based on offset information of the video image or based on a screen having zero (0) disparity.

The apparatus may further include that the extracting of the 3D reproduction information comprises extracting at least one of: offset information according to pages and offset information according to regions in a page.

The apparatus may further include that: the additional data comprises a subtitle message; and the subtitle decoder is further configured to extract the 3D reproduction information from the subtitle message.

The apparatus may further include that: the subtitle message comprises simple bitmap information; and the subtitle decoder is further configured to extract the 3D reproduction information from the simple bitmap information.

The apparatus may further include that the subtitle decoder is further configured to: extract the offset information from the simple bitmap information; and extract the offset direction from the subtitle message.

The apparatus may further include that: the subtitle message further comprises a descriptor defining the 3D reproduction information; and the subtitle decoder is further configured to extract the 3D reproduction information from the descriptor included in the subtitle message.

The apparatus may further include that the descriptor comprises offset information about: at least one of: a character and a frame; and the offset direction.

The apparatus may further include that: the subtitle message further comprises a subtitle type; and in response to the subtitle type indicating another view subtitle, the subtitle message further comprises information about the other view subtitle.

The apparatus may further include that the information about the other view subtitle comprises frame coordinates of the other view subtitle.

The apparatus may further include that the information about the other view subtitle comprises disparity information of the other view subtitle with respect to a reference view subtitle.

The apparatus may further include that the information about the other view subtitle comprises information about a subtitle bitmap for generating the other view subtitle.

The apparatus may further include that the 3D reproduction information further comprises information about whether the 3D reproduction information is generated based on offset information of the video image or based on a screen having zero (0) disparity.

The apparatus may further include that the 3D reproduction information comprises at least one of: offset information according to pages; and offset information according to regions in a page.

In another general aspect, there is provided a computer-readable recording medium having recorded thereon additional data for generating a subtitle that is reproduced with a video image, the additional data comprising text subtitle data, the text subtitle data comprising a dialog style segment and a dialog presentation segment, the dialog presentation segment comprising three-dimensional (3D) reproduction information for reproducing the subtitle in 3D.

In another general aspect, there is provided a computer-readable recording medium having recorded thereon additional data for generating a subtitle that is reproduced with a video image, the additional data comprising subtitle data, the subtitle data comprising a composition page, the composition page comprising a page composition segment, the page composition segment comprising three-dimensional (3D) reproduction information for reproducing the subtitle in 3D.

In another general aspect, there is provided a computer-readable recording medium having recorded thereon additional data for generating a subtitle that is reproduced with a video image, the additional data comprising subtitle data, the subtitle data comprising a subtitle message, and the subtitle message comprising three-dimensional (3D) reproduction information for reproducing the subtitle in 3D.

Other features and aspects may be apparent from the following detailed description, the drawings, and the claims.

### BRIEF DESCRIPTION OF THE DRAWINGS

FIG. 1 is a block diagram of an apparatus for generating a multimedia stream for three-dimensional (3D) reproduction of additional reproduction information, according to an embodiment.

FIG. 2 is a block diagram of an apparatus for receiving a multimedia stream for 3D reproduction of additional reproduction information, according to an embodiment.

FIG. 3 illustrates a scene in which a 3D video and 3D additional reproduction information are simultaneously reproduced.

FIG. 4 illustrates a phenomenon in which a 3D video and 3D additional reproduction information are reversed and reproduced.

FIG. 5 is a diagram of a text subtitle stream according to an embodiment.

FIG. 6 is a table of syntax indicating that 3D reproduction information is included in a dialog presentation segment, according to an embodiment.

FIG. 7 is a flowchart illustrating a method of processing a signal, according to an embodiment.

FIG. 8 is a block diagram of an apparatus for processing a signal, according to an embodiment.

FIG. 9 is a diagram illustrating a left-eye graphic and a right-eye graphic, which are generated by using 3D reproduction information, overlaid respectively on a left-eye video image and a right-eye video image, according to an embodiment.

FIG. 10 is a diagram for describing an encoding apparatus for generating a multimedia stream, according to an embodiment.

FIG. 11 is a diagram of a hierarchical structure of a subtitle stream complying with a digital video broadcasting (DVB) communication method.

FIG. 12 is a diagram illustrating a subtitle descriptor and a subtitle packetized elementary stream (PES) packet, when at least one subtitle service is multiplexed into one packet.

FIG. 13 is a diagram illustrating a subtitle descriptor and a subtitle PES packet, when a subtitle service is formed in an individual packet.

FIG. 14 is a diagram of a structure of a datastream including subtitle data complying with a DVB communication method, according to an embodiment.

FIG. 15 is a diagram of a structure of a composition page complying with a DVB communication method, according to an embodiment.

FIG. 16 is a flowchart illustrating a subtitle processing model complying with a DVB communication method.

FIGS. 17 through 19 are diagrams illustrating data respectively stored in a coded data buffer, a composition buffer, and a pixel buffer.

FIG. 20 is a diagram of a structure of a composition page of subtitle data complying with a DVB communication method, according to an embodiment.

FIG. 21 is a diagram of a structure of a composition page of subtitle data complying with a DVB communication method, according to another embodiment.

FIG. 22 is a diagram for describing adjusting of depth of a subtitle according to regions, according to an embodiment.

FIG. 23 is a diagram for describing adjusting of depth of a subtitle according to pages, according to an embodiment.

FIG. 24 is a diagram illustrating components of a bitmap format of a subtitle following a cable broadcasting method.

FIG. 25 is a flowchart of a subtitle processing model for 3D reproduction of a subtitle complying with a cable broadcasting method, according to an embodiment.

FIG. 26 is a diagram for describing a process of a subtitle being output from a display queue to a graphic plane through a subtitle processing model complying with a cable broadcasting method.

FIG. 27 is a flowchart of a subtitle processing model for 3D reproduction of a subtitle following a cable broadcasting method, according to another embodiment.

FIG. 28 is a diagram for describing adjusting of depth of a subtitle complying with a cable broadcasting method, according to an embodiment.

FIG. 29 is a diagram for describing adjusting of depth of a subtitle complying with a cable broadcasting method, according to another embodiment.

FIG. 30 is a diagram for describing adjusting of depth of a subtitle complying with a cable broadcasting method, according to another embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

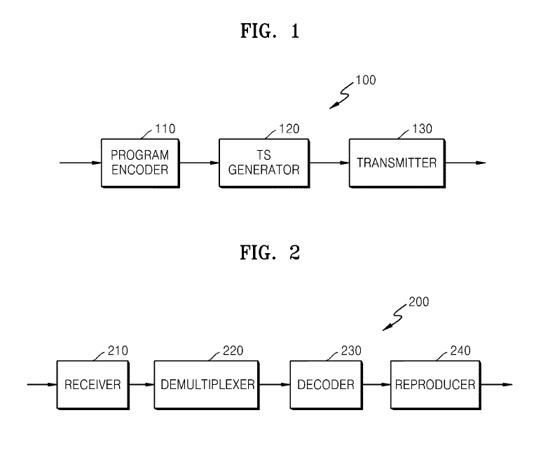

FIG. 1 is a block diagram of an apparatus 100 for generating a multimedia stream for three-dimensional (3D) reproduction of additional reproduction information, according to an embodiment.

The apparatus 100 according to an embodiment includes a program encoder 110, a transport stream (TS) generator 120, and a transmitter 130.

The program encoder 110 according to an embodiment receives data of additional reproduction information with encoded video data and encoded audio data.

For convenience of description, information, such as a subtitle or a menu, displayed on a screen with a video image will be referred to herein as “additional reproduction information” and data for generating the additional reproduction information will be referred to herein as “additional data.” The additional data may include text subtitle data, subtitle data, subtitle message, etc.

According to an embodiment, a depth of the additional reproduction information may be adjusted so that a subtitle is reproduced in 3D with a 3D video image. The program encoder 110 according to an embodiment may generate additional data in such a way that information for reproducing the additional reproduction information in 3D is included in the additional data. The information for reproducing the additional reproduction information, such as a subtitle, in 3D will be referred to herein as “3D reproduction information”.

The program encoder 110 may generate a video elementary stream (ES), an audio ES, and an additional data stream by using encoded additional data including encoded video data, encoded audio data, and 3D reproduction information. According to an embodiment, the program encoder 110 may further generate an ancillary information stream by using ancillary information including various types of data, such as control data. The ancillary information stream may include program specific information (PSI), such as a program map table (PMT) or a program association table (PAT), or section information, such as advanced television standards committee program specific information protocol (ATSC PSIP) information or digital video broadcasting service information (DVB SI).

The program encoder 110 according to an embodiment may generate a video packetized elementary stream (PES) packet, an audio PES packet, and an additional data PES packet by packetizing the video ES, the audio ES, and the additional data stream, and generates an ancillary information packet.

The TS generator 120 according to an embodiment may generate a TS by multiplexing the video PES packet, the audio PES packet, the additional data PES packet, and the ancillary information packet, which are output from the program encoder 110. The transmitter 130 according to an embodiment may transmit the TS output from the TS generator 120 to a predetermined channel.

When the additional reproduction information is a subtitle, a signal outputting apparatus (not shown) may respectively generate a left-eye subtitle and a right-eye subtitle and alternately output the left-eye subtitle and the right-eye subtitle by using the 3D reproduction information, in order to reproduce the subtitle in 3D. Information indicating a depth of a subtitle and which is included in the 3D reproduction information will be referred to herein as “offset information.” The offset information may include at least one of a movement value, which indicates a distance to move a region where the subtitle is displayed from an original location to generate the left-eye subtitle and the right-eye subtitle, a depth value, which indicates a depth of the subtitle when the region where the subtitle is displayed is reproduced in 3D, disparity between the left-eye subtitle and the right-eye subtitle, and parallax.

In the following embodiments, even when any one of the disparity, the depth value, and the movement value that is indicated in coordinates from among the offset information is used in an embodiment, the same embodiment may be realized by using any other one from among the offset information.

The offset information of the additional reproduction information, according to an embodiment may include a relative movement amount of one of the left-eye and right-eye subtitles compared to a location of the other.

The offset information of the additional reproduction information may be generated based on depth information of the video image reproduced with the subtitle, e.g., based on offset information of the video image. The offset information of the video image may include at least one of a movement value, which indicates a distance to move the video image from an original location in a left-eye image and a right-eye image, a depth value of the video image, which indicates a depth of the video image when the video image is reproduced in 3D, disparity between the left-eye and right-eye images, and parallax. Also, the offset information of the video image may further include an offset direction indicating a direction in which the movement value, the depth value, disparity, or the like is applied. The offset information of the additional reproduction information may include a relative movement amount or a relative depth value compared to one of the offset information of the video image.

The offset information of the additional reproduction information, according to an embodiment may be generated based on a screen in which a video image or a subtitle is reproduced in two dimensions (2D), e.g., based on a zero plane (zero parallax), instead of the depth value, the disparity, or the parallax relative to the video image.

The 3D reproduction information according to an embodiment may further include a flag indicating whether the offset information of the additional reproduction information has an absolute value based on the zero plane, or a relative value based on the offset information of the video image, such as the depth value or the movement value of the video image.

The 3D reproduction information may further include the offset direction indicating the direction in which the offset information is applied. The offset information shows a direction in which to move the subtitle, e.g., to the left or right, while generating at least one of the left-eye subtitle and the right-eye subtitle. The offset direction may indicate any one of the right direction or the left direction, but may also indicate parallax. Parallax is classified into positive parallax, zero parallax, and negative parallax. When the offset direction is positive parallax, the subtitle is located deeper than the screen. When the offset direction is negative parallax, the subtitle protrudes from the screen to create a 3D effect. When the offset direction is zero parallax, the subtitle is located on the screen in 2D.

The 3D reproduction information of the additional reproduction information, according to an embodiment may further include information distinguishing a region where the additional reproduction information is to be displayed, e.g., a region where the subtitle is displayed.

When the apparatus 100 complies with an optical recording method defined by Blu-ray Disc Association (BDA), according to an embodiment, the program encoder 110 may generate a text subtitle ES including text subtitle data for the subtitle, along with the video ES and the audio ES. The program encoder 110 may insert the 3D reproduction information into the text subtitle ES.

For example, the program encoder 110 may insert the 3D reproduction information into a dialog presentation segment included in the text subtitle data.

When the apparatus 100 complies with a digital video broadcasting (DVB) method, according to another embodiment, the program encoder 110 may generate a subtitle PES packet by generating an additional data stream including subtitle data along with the video ES and the audio ES. For example, the program encoder 110 may insert the 3D reproduction information in a page composition segment into a composition page included in the subtitle data. Alternatively, the program encoder 110 may generate a new segment defining the 3D reproduction information, and insert the new segment into the composition page included in the subtitle data. The program encoder 110 may insert at least one of offset information according to pages, which is commonly applied to pages of the subtitle, and offset information according to regions, which is applied to each region, into a page of the subtitle.

When the apparatus 100 complies with an American National Standard Institute/Society of Cable Telecommunications Engineers (ANSI/SCTE) method, according to another embodiment, the program encoder 110 may generate a subtitle PES packet by generating a data stream including subtitle data along with the video ES and the audio ES. For example, the program encoder 110 may insert the 3D reproduction information into at least one of the subtitle PES packet and a header of the subtitle PES packet. The 3D reproduction information may include offset information about at least one of a bitmap and a frame, and the offset direction.

The program encoder 110 according to an embodiment may insert offset information, which is applied to both of a character element and a frame element of the subtitle, into a subtitle message in the subtitle data. Alternatively, the program encoder 110 may insert at least one of offset information about the character elements of the subtitle, and offset information about the frame element of the subtitle separately into the subtitle data.

The program encoder 110 according to an embodiment may add subtitle type information indicating information about another view subtitle from among the left-eye and right-eye subtitles, to the 3D reproduction information. For example, the program encoder 110 may additionally insert offset information including coordinates about the other view subtitle into the 3D reproduction information.

The program encoder 110 according to an embodiment may add a subtitle disparity type to subtitle type information, and additionally insert disparity information of the other view subtitle from among the left-eye and right-eye subtitles compared to a reference view subtitle into the 3D reproduction information.

Accordingly, in order to reproduce the subtitle according to a Blu-ray Disc (BD) method, a DVB method, or a cable broadcasting method, the apparatus 100 according to an embodiment may generate 3D reproduction information according to a corresponding communication method, generates an additional data stream by inserting the generated 3D reproduction information into additional data, and multiplexes and transmits the additional data stream with video ES data, audio ES stream, or an ancillary stream.

A receiver (e.g., receiver 210 in FIG. 2) may use the 3D reproduction information to reproduce the additional reproduction information in 3D with video data.

The apparatus 100 according to an embodiment maintains compatibility with various communication methods, such as the BD method, the DVB method based on an exiting MPEG TS method, and the cable broadcasting method, and may multiplex and transmit the additional data, into which the 3D reproduction information is inserted, with the video ES and the audio ES.

FIG. 2 is a block diagram of an apparatus 200 for receiving a multimedia stream for 3D dimensional reproduction of additional reproduction information, according to an embodiment.

The apparatus 200 according to an embodiment includes a receiver 210, a demultiplexer 220, a decoder 230, and a reproducer 240.

The receiver 210 according to an embodiment may receive a TS about a multimedia stream including video data including at least one of a 2D video image and a 3D video image. The multimedia stream may include additional data including a subtitle to be reproduced with the video data. According to an embodiment, the additional data may include 3D reproduction information for reproducing the additional data in 3D.

The demultiplexer 220 according to an embodiment may extract a video PES packet, an audio PES packet, an additional data PES packet, and an ancillary information packet by receiving and demultiplexing the TS from the receiver 210.

The demultiplexer 220 according to an embodiment may extract a video ES, an audio ES, an additional data stream, and program related information from the video PES packet, the audio PES packet, the additional data PES packet, and the ancillary information packet. The additional data stream may include the 3D reproduction information.

The decoder 230 according to an embodiment may receive the video ES, the audio ES, the additional data stream, and the program related information from the demultiplexer 220; may restore video, audio, additional data, and additional reproduction information respectively from the received video ES, the audio ES, the additional data stream, and the program related information; and may extract the 3D reproduction information from the additional data.

The reproducer 240 according to an embodiment may reproduce the video and the audio restored by the decoder 230. Also, the reproducer 240 may reproduce the additional data in 3D based on the 3D reproduction information.

The additional data and the 3D reproduction information extracted and used by the apparatus 200 correspond to the additional data and the 3D reproduction information described with reference to the apparatus 100 of FIG. 1.

The reproducer 240 according to an embodiment may reproduce the additional reproduction information, such as a subtitle, by moving the additional reproduction information in an offset direction from a reference location by an offset, based on the offset and the offset direction included in the 3D reproduction information.

The reproducer 240 according to an embodiment may reproduce the additional reproduction information in such a way that the additional reproduction information is displayed at a location positively or negatively moved by an offset compared to a 2D zero plane. Alternatively, the reproducer 240 may reproduce the additional reproduction information in such a way that the additional reproduction information is displayed at a location positively or negatively moved by an offset included in the 3D reproduction information, based on offset information of a video image that is to be reproduced with the additional reproduction information, e.g., based on a depth, disparity, and parallax of the video image.

The reproducer 240 according to an embodiment may reproduce the subtitle in 3D by displaying one of the left-eye and right-eye subtitles at a location positively moved by an offset compared to an original location, and the other at a location negatively moved by the offset compared to the original location.

The reproducer 240 according to an embodiment may reproduce the subtitle in 3D by displaying one of the left-eye and right-eye subtitles at a location moved by an offset, compared to the other.

The reproducer 240 according to an embodiment may reproduce the subtitle in 3D by moving locations of the left-eye and right-eye subtitles based on offset information independently set for the left-eye and right-eye subtitles.

When the apparatus 200 complies with an optical recording method defined by BDA, according to an embodiment, the demultiplexer 220 may extract an additional data stream including not only a video ES and an audio ES, but also text subtitle data, from a TS. For example, the decoder 230 may extract the text subtitle data from the additional data stream. Also, the demultiplexer 220 or the decoder 230 may extract 3D reproduction information from a dialog presentation segment included in the text subtitle data. According to an embodiment, the dialog presentation segment may include a number_of_regions on which the subtitle is displayed, and a number of pieces of offset information equaling the number of regions.

When the apparatus 200 complies with the DVB method, according to another embodiment, the demultiplexer 220 may not only extract the video ES and the audio ES, but also the additional data stream including subtitle data from the TS. For example, the decoder 230 may extract the subtitle data in a subtitle segment form from the additional data stream. The decoder 230 may extract the 3D reproduction information from a page composition segment in a composition page included in the subtitle data. The decoder 230 may additionally extract at least one of offset information according to pages of the subtitle and offset information according to regions in a page of the subtitle, from the page composition segment.

According to an embodiment, the decoder 230 may extract the 3D reproduction information from a depth definition segment newly defined in the composition page included in the subtitle data.

When the apparatus 200 complies with an ANSI/SCTE method, according to another embodiment, the demultiplexer 220 may not only extract the video ES and the audio ES, but also the additional data stream including the subtitle data, from the TS. The decoder 230 according to an embodiment may extract the subtitle data from the additional data stream. The subtitle data includes a subtitle message. In an embodiment, the demultiplexer 220 or the decoder 230 may extract the 3D reproduction information from at least one of the subtitle PES packet and the header of the subtitle PES packet.

The decoder 230 according to an embodiment may extract offset information that is commonly applied to a character element and a frame element of the subtitle or offset information that is independently applied to the character element and the frame element, from the subtitle message in the subtitle data. The decoder 230 may extract the 3D reproduction information from simple bitmap information included in the subtitle message. The decoder 230 may extract the 3D reproduction information from a descriptor defining the 3D reproduction information and which is included in the subtitle message. The descriptor may include offset information about at least one of a character and a frame, and an offset direction.

The subtitle message may include a subtitle type. When the subtitle type indicates another view subtitle, the subtitle message may further include information about the other view subtitle. The information about the other view subtitle may include offset information of the other view subtitle, such as frame coordinates, a depth value, a movement value, parallax, or disparity. Alternatively, the information about the other view subtitle may include a movement value, disparity, or parallax of the other view subtitle with reference to a reference view subtitle.

For example, the decoder 230 may extract the information about the other view subtitle included in the subtitle message, and generate the other view subtitle by using the information about the other view subtitle.

The apparatus 200 may extract the additional data and the 3D reproduction information from the received multimedia stream, generate the left-eye subtitle and the right-eye subtitle by using the additional data and the 3D reproduction information, and reproduce the subtitle in 3D by alternately reproducing the left-eye subtitle and the right-eye subtitle, according to a BD, DVB, or cable broadcasting method.

The apparatus 200 may maintain compatibility with various communication methods, such as the BD method based on an existing MPEG TS method, the DVB method, and the cable broadcasting method, and may reproduce the subtitle in 3D while reproducing a 3D video.

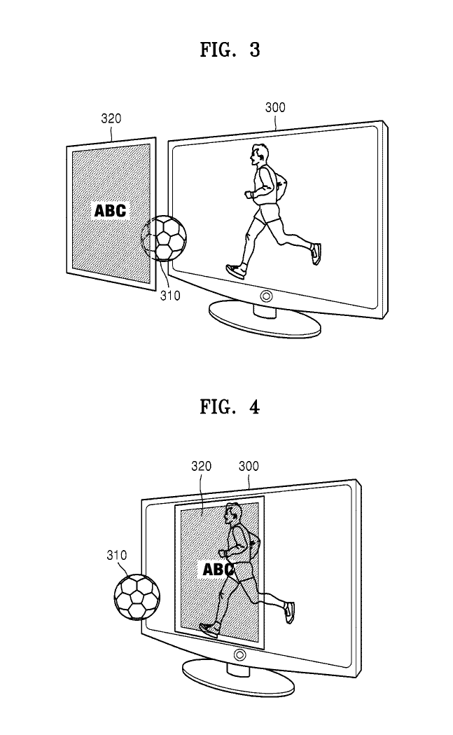

FIG. 3 illustrates a scene in which a 3D video and 3D additional reproduction information are simultaneously reproduced.

Referring to FIG. 3, a text screen 320, on which additional reproduction information such as a subtitle or a menu, may protrude toward a viewer compared to objects 300 and 310 of a video image, so that the viewer views the video image and the additional reproduction information without fatigue or disharmony.

FIG. 4 illustrates a phenomenon in which a 3D video and 3D additional reproduction information are reversed and reproduced. As shown in FIG. 4, when the text screen 320 is reproduced further than the object 310 from the viewer, the object 310 may cover the text screen 320. For example, the viewer may be fatigued or feel disharmony while viewing a video image and additional reproduction information.

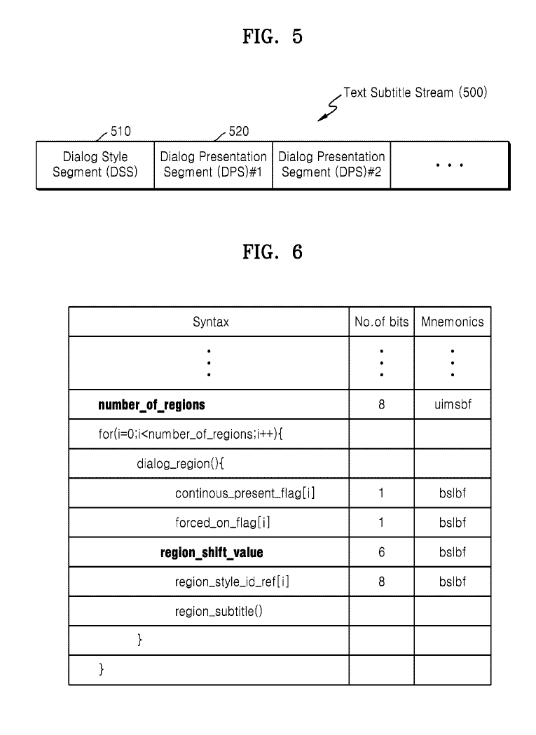

A method and apparatus for reproducing a text subtitle in 3D by using 3D reproduction information, according to an embodiment will now be described with reference to FIGS. 5 through 9.

FIG. 5 is a diagram of a text subtitle stream 500 according to an embodiment.

The text subtitle stream 500 may include a dialog style segment (DSS) 510 and at least one dialog presentation segment (DPS) 520.

The dialog style segment 510 may store style information to be applied to the dialog presentation segment 520, and the dialog presentation segment 520 may include dialog information.

The style information included in the dialog style segment 510 may be information about how to output a text on a screen, and may include at least one of dialog region information indicating a dialog region where a subtitle is displayed on the screen, text box region information indicating a text box region included in the dialog region and on which the text is written, and font information indicating a type, a size, or the like, of a font to be used for the subtitle.

The dialog region information may include at least one of a location where the dialog region is output based on an upper left point of the screen, a horizontal axis length of the dialog region, and a vertical axis length of the dialog region. The text box region information may include a location where the text box region is output based on a top left point of the dialog region, a horizontal axis length of the text box region, and the vertical axis length of the text box region.

As a plurality of dialog regions may be output in different locations on one screen, the dialog style segment 510 may include dialog region information for each of the plurality of dialog regions.

The dialog information included in the dialog presentation segment 520 may be converted into a bitmap on a screen, e.g., is rendered, and may include at least one of a text string to be displayed on a subtitle, reference style information to be used while rendering the text information, and dialog output time information designating a period of time for the subtitle to appear and disappear on the screen. The dialog information may include in-line format information for emphasizing a part of the subtitle by applying the in-line format only to the part.

According to an embodiment, the 3D reproduction information for reproducing the text subtitle data in 3D may be included in the dialog presentation segment 520. The 3D reproduction information may be used to adjust a location of the dialog region on which the subtitle is displayed, in the left-eye and right-eye subtitles. The reproducer 240 of FIG. 2 may adjust the location of the dialog region by using the 3D reproduction information to reproduce the subtitle output in the dialog region, in 3D. The 3D reproduction information may include a movement value of the dialog region from an original location, a coordinate value for the dialog region to move, or offset information, such as a depth value, disparity, and parallax. Also, the 3D reproduction information may include an offset direction in which the offset information is applied.

When there are a plurality of dialog regions for the text subtitle to be output on one screen, 3D reproduction information including offset information about each of the plurality of dialog regions may be included in the dialog presentation segment 520. The reproducer 240 may adjust the locations of the dialog regions by using the 3D reproduction information for each of the dialog regions.

According to the embodiments, the dialog style segment 510 may include the 3D reproduction information for reproducing the dialog region in 3D.

FIG. 6 is a table of syntax indicating that 3D reproduction information is included in the dialog presentation segment 520, according to an embodiment. For convenience of description, only some pieces of information included in the dialog presentation segment 520 are shown in the table of FIG. 6.

A syntax “number_of_regions” indicates a number of dialog regions. At least one dialog region may be defined, and when a plurality of dialog regions are simultaneously output on one screen, the plurality of dialog regions may be defined. When there are a plurality of dialog regions, the dialog presentation segment 520 may include the 3D reproduction information to be applied to each of the dialog regions.

In FIG. 6, a syntax “region shift value” indicates the 3D reproduction information. The 3D reproduction information may include a movement direction or distance for the dialog region to move, a coordinate value, a depth value, etc.

As described above, the 3D reproduction information may be included in the text subtitle stream.

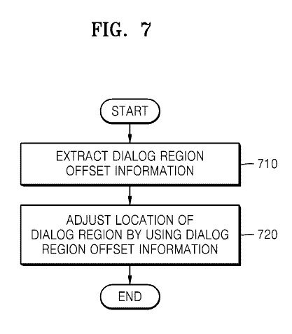

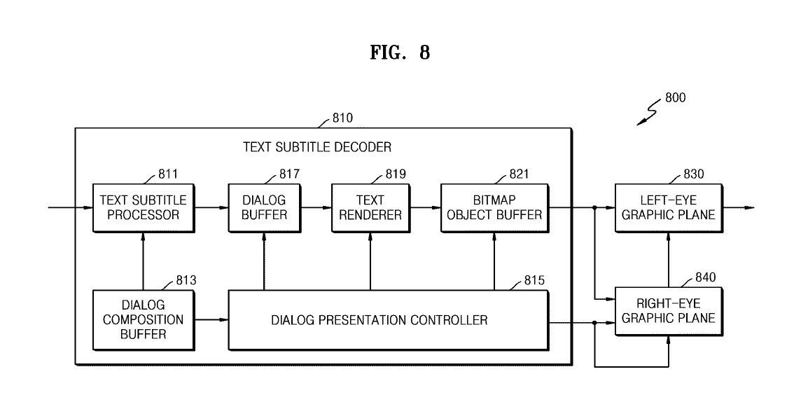

FIG. 7 is a flowchart illustrating a method of processing a signal, according to an embodiment. Referring to FIG. 7, an apparatus for processing a signal may extract dialog region offset information in operation 710. The apparatus may extract the dialog region offset information from the dialog presentation segment 520 of FIG. 5 included in the text subtitle data. A plurality of dialog regions may be simultaneously output on one screen. For example, the apparatus may extract the dialog region offset information for each dialog region.

The apparatus may adjust a location of the dialog region on which a subtitle is displayed, by using the dialog region offset information, in operation 720. The apparatus may extract dialog region information from the dialog style segment 510 of FIG. 5 included in the text subtitle data, and may obtain a final location of the dialog region by using the dialog region information and the dialog region offset information.

In response to a plurality of pieces of dialog region offset information existing, the apparatus may adjust locations of each dialog region by using the dialog region offset information of each dialog region.

As described above, the subtitle included in the dialog region may be reproduced in 3D by using the dialog region offset information.

FIG. 8 is a block diagram of an apparatus 800 for processing a signal, according to an embodiment. The apparatus 800 may reproduce a subtitle in 3D by using text subtitle data, and may include a text subtitle decoder 810, a left-eye graphic plane 830, and a right-eye graphic plane 840.

The text subtitle decoder 810 may generate a subtitle by decoding text subtitle data. The text subtitle decoder 810 may include a text subtitle processor 811, a dialog composition buffer 813, a dialog presentation controller 815, a dialog buffer 817, a text renderer 819, and a bitmap object buffer 821.

A left-eye graphic and a right-eye graphic may be drawn respectively on the left-eye graphic plane 830 and the right-eye graphic plane 840. The left-eye graphic corresponds to a left-eye subtitle and the right-eye graphic corresponds to a right-eye subtitle. The apparatus 800 may overlay the left-eye subtitle and the right-eye subtitle drawn on the left-eye graphic plane 830 and the right-eye graphic plane 840, respectively, on a left-eye video image and a right-eye video image, and may alternately output the left-eye video image and the right-eye video image in units of, e.g., 1/120 seconds.

The left-eye graphic plane 830 and the right-eye graphic plane 840 are both shown in FIG. 8, but only one graphic plane may be included in the apparatus 800. For example, the apparatus 800 may reproduce a subtitle in 3D by alternately drawing the left-eye subtitle and the right-eye subtitle on one graphic plane.

A packet identifier (PID) filter (not shown) may filter the text subtitle data from the TS, and transmit the filtered text subtitle data to a subtitle preloading buffer (not shown). The subtitle preloading buffer may pre-store the text subtitle data and transmit the text subtitle data to the text subtitle decoder 810.

The dialog presentation controller 815 may extract the 3D reproduction information from the text subtitle data and may reproduce the subtitle in 3D by using the 3D reproduction information, by controlling the overall operations of the apparatus 800.

The text subtitle processor 811 included in the text subtitle decoder 810 may transmit the style information included in the dialog style segment 510 to the dialog composition buffer 813. Also, the text subtitle processor 811 may transmit the inline style information and the text string to the dialog buffer 817 by parsing the dialog presentation segment 520, and may transmit the dialog output time information, which designates the period of time for the subtitle to appear and disappear on the screen, to the dialog composition buffer 813.

The dialog buffer 817 may store the text string and the inline style information, and the dialog composition buffer 813 may store information for rendering the dialog style segment 510 and the dialog presentation segment 520.

The text renderer 819 may receive the text string and the inline style information from the dialog buffer 817, and may receive the information for rendering from the dialog composition buffer 813. The text renderer 819 may receive font data from a font preloading buffer (not shown). The text renderer 819 may convert the text string to a bitmap object by referring to the font data and applying the style information included in the dialog style segment 510. The text renderer 819 may transmit the generated bitmap object to the bitmap object buffer 821.

In response to a plurality of dialog regions being included in the dialog presentation segment 520, the text renderer 819 may generate a plurality of bitmap objects according to each dialog region.

The bitmap object buffer 821 may store the rendered bitmap object, and may output the rendered bitmap object on a graphic plane according to control of the dialog presentation controller 815. The dialog presentation controller 815 may determine a location where the bitmap object is to be output by using the dialog region information stored in the text subtitle processor 811, and may control the bitmap object to be output on the location.

The dialog presentation controller 815 may determine whether the apparatus 800 is able to reproduce the subtitle in 3D. If the apparatus 800 is unable to reproduce the subtitle in 3D, the dialog presentation controller 815 may output the bitmap object at a location indicated by the dialog region information to reproduce the subtitle in 2D. If the apparatus 800 is able to reproduce the subtitle in 3D, the dialog presentation controller 815 may extract the 3D reproduction information. The dialog presentation controller 815 may reproduce the subtitle in 3D by adjusting the location of the bitmap object, which is stored in the bitmap object buffer 821, drawn on the graphic plane by using the 3D reproduction information. In other words, the dialog presentation controller 815 may determine an original location of the dialog region by using the dialog region information extracted from the dialog style segment 510, and may adjust the location of the dialog region from the original location, according to the movement direction and the movement value included in the 3D reproduction information.

The dialog presentation controller 815 may extract the 3D reproduction information from the dialog presentation segment 520 included in the text subtitle data, and then may identify and extract the 3D reproduction information from a dialog region offset table.

In response to there being two graphic planes in the apparatus 800, the dialog presentation controller 815 may determine whether to move the dialog region to the left on the left-eye graphic plane 830 and to the right on the right-eye graphic plane 840, or to move the dialog region to the right on the left-eye graphic plane 830 and to the left on the right-eye graphic plane 840, by using the movement direction included in the 3D reproduction information.

The dialog presentation controller 815 may locate the dialog region at a location corresponding to the coordinates included in the 3D reproduction information in the determined movement direction, or at a location that is moved according to the movement value or the depth value included in the 3D reproduction information, on the left-eye graphic plane 830 and the right-eye graphic plane 840.

In response to there being only one graphic plane in the apparatus 800, the dialog presentation controller 815 may alternately transmit the left-eye graphic for the left-eye subtitle and the right-eye graphic for the right-eye subtitle to one graphic plane. In other words, the apparatus 800 may transmit the dialog region on the graphic plane while moving the dialog region in an order of left to right or of right to left after moving the dialog region by the movement value, according to the movement direction indicated by the 3D reproduction information.

As described above, the apparatus 800 may reproduce the subtitle in 3D by adjusting the location of the dialog region on which the subtitle is displayed, by using the 3D reproduction information.

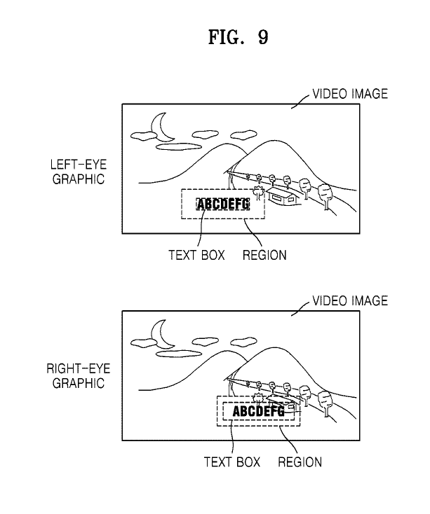

FIG. 9 is a diagram illustrating a left-eye graphic and a right-eye graphic, which may be generated by using 3D reproduction information, overlaid respectively on a left-eye video image and a right-eye video image, according to an embodiment.

Referring to FIG. 9, a dialog region may be indicated as REGION in the left-eye graphic and the right-eye graphic, and a text box including a subtitle may be disposed within the dialog region. The dialog regions may be moved by a predetermined value to opposite directions in the left-eye graphic and the right-eye graphic. As a location of the text box to which the subtitle is output may be based on the dialog region, when the dialog region moves, the text box may also move. Accordingly, a location of the subtitle output to the text box may also move. When the left-eye and right-eye graphics are alternately reproduced, a viewer may view the subtitle in 3D.

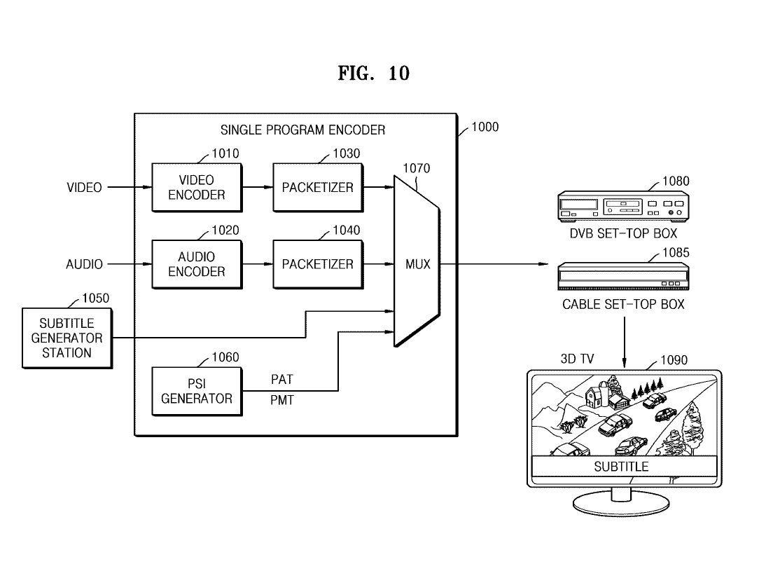

FIG. 10 is a diagram for describing an encoding apparatus for generating a multimedia stream, according to an embodiment. Referring to FIG. 10, a single program encoder 1000 may include a video encoder 1010, an audio encoder 1020, packetizers 1030 and 1040, a PSI generator 1060, and a multiplexer (MUX) 1070.

The video encoder 1010 and the audio encoder 1020 may respectively receive and encode video data and audio data. The video encoder 1010 and the audio encoder 1020 may transmit the encoded video data and the audio data respectively to the packetizers 1030 and 1040. The packetizers 1030 and 1040 may packetize data to respectively generate video PES packets and audio PES packets. In an embodiment, the single program encoder 1000 may receive subtitle data from a subtitle generator station 1050. In FIG. 10, the subtitle generator station 1050 is a separate unit from the single program encoder 1000, but the subtitle generator station 1050 may be included in the single program encoder 1000.

The PSI generator 1060 may generate information about various programs, such as a PAT and PMT.

The MUX 1070 may not only receive the video PES packets and audio PES packets from the packetizers 1030 and 1040, but may also receive a subtitle data packet in a PES packet form, and the information about various programs in a section form from the PSI generator 1060, and may generate and output a TS about one program by multiplexing the video PES packets, the audio PES packets, the subtitle data packet, and the information about various programs.

When the single program encoder 1000 has generated and transmitted the TS according to a DVB communication method, a DVB set-top box 1080 may receive the TS and, and may parse the TS to restore the video data, the audio data, and the subtitle.

When the single program 1000 has generated and transmitted the TS according to a cable broadcasting method, a cable set-top box 1085 may receive the TS and parse the TS to restore the video data, the audio data, and the subtitle. A television (TV) 1090 may reproduce the video data and the audio data, and may reproduce the subtitle by overlaying the subtitle on a video image.

A method and apparatus for reproducing a subtitle in 3D by using 3D reproduction information generated and transmitted according to a DVB communication method, according to another embodiment will now be described.

The method and apparatus according to an embodiment will be described with reference to Tables 1 through 21 and FIGS. 10 through 23.

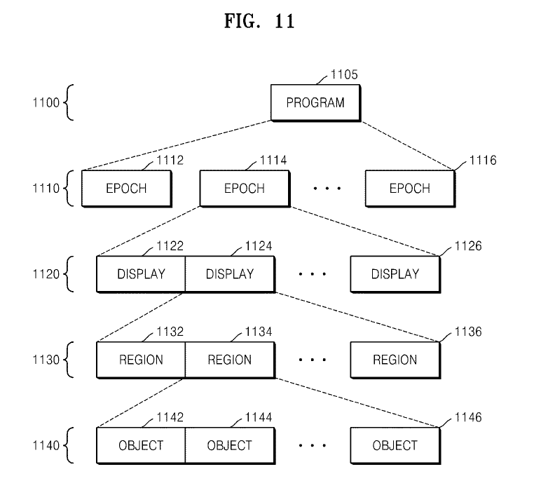

FIG. 11 is a diagram of a hierarchical structure of a subtitle stream complying with a DVB communication method. The subtitle stream may have the hierarchical structure of a program level 1100, an epoch level 1110, a display sequence level 1120, a region level 1130, and an object level 1140.

The subtitle stream may be configured in a unit of epochs 1112, 1114, and 1116, considering an operation model of a decoder. Data included in one epoch may be stored in a buffer of a subtitle decoder until data in a next epoch is transmitted to the buffer. One epoch, for example, the epoch 1114, may include at least one of display sequence units 1122, 1124, and 1126.

The display sequence units 1122, 1124, and 1126 may indicate a complete graphic scene and may be maintained on a screen for several seconds. Each of the display sequence units 1122, 1124, and 1126, for example, the display sequence unit 1124, may include at least one of region units 1132, 1134, and 1136. The region units 1132, 1134, and 1136 may be regions having horizontal and vertical sizes, and a predetermined color, and may be regions where a subtitle is output on a screen. Each of the region units 1132, 1134, and 1136, for example, the region unit 1134, may include objects 1142, 1144, and 1146, which are subtitles to be displayed, e.g., in the region unit 1134.

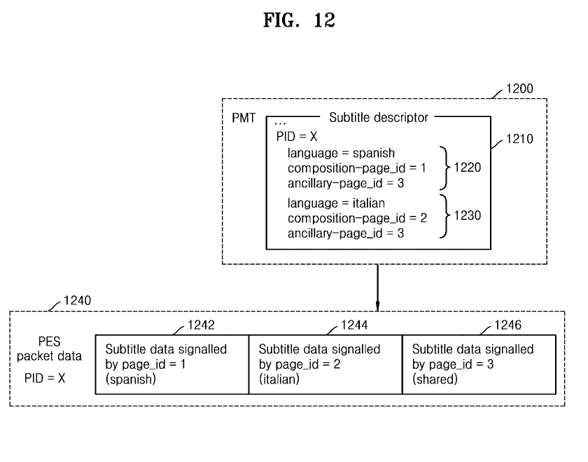

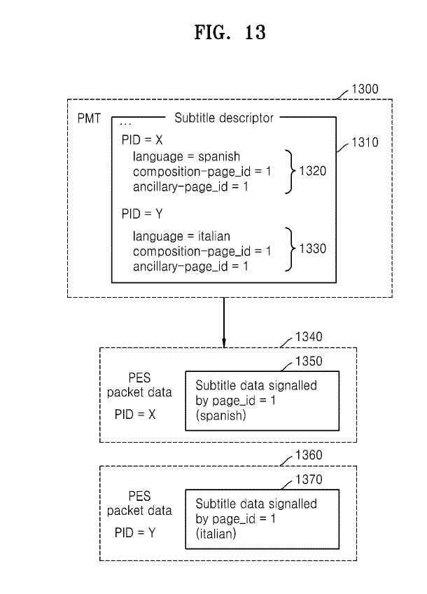

FIGS. 12 and 13 illustrate two expression types of a subtitle descriptor in a PMT indicating a PES packet of a subtitle, according to a DVB communication method.

One subtitle stream may transmit at least one subtitle service. The at least one subtitle service may be multiplexed to one packet, and the packet may be transmitted with one piece of PID information. Alternatively, each subtitle service may be configured to an individual packet, and each packet may be transmitted with individual PID information. A related PMT may include the PID information about the subtitle service, language, and a page identifier.

FIG. 12 is a diagram illustrating a subtitle descriptor and a subtitle PES packet, when at least one subtitle service is multiplexed into one packet. In FIG. 12, at least one subtitle service may be multiplexed to a PES packet 1240 and may be assigned with the same PID information X, and accordingly, a plurality of pages 1242, 1244, and 1246 for the subtitle service may be subordinated to the same PID information X.

Subtitle data of the page 1246, which is an ancillary page, may be shared with other subtitle data of the pages 1242 and 1244.

A PMT 1200 may include a subtitle descriptor 1210 about the subtitle data. The subtitle descriptor 1210 defines information about the subtitle data according to packets. In the same packet, information about subtitle services may be classified according to pages. In other words, the subtitle descriptor 1210 may include information about the subtitle data in the pages 1242, 1244, and 1246 in the PES packet 1240 having the PID information X. Subtitle data information 1220 and 1230, which are respectively defined according to the pages 1242 and 1244 in the PES packet 1240, may include language information “language”, a composition page identifier “composition-page_id”, and an ancillary page identifier “ancillary-page_id”.

FIG. 13 is a diagram illustrating a subtitle descriptor and a subtitle PES packet, when a subtitle service is formed in an individual packet. A first page 1350 for a first subtitle service may be formed of a first PES packet 1340, and a second page 1370 for a second subtitle service may be formed of a second PES packet 1360. The first and second PES packets 1340 and 1360 may be respectively assigned with PID information X and Y.

A subtitle descriptor 1310 of a PMT 1300 may include PID information values of a plurality of subtitle PES packets, and may define information about the subtitle data of the PES packets according to PES packets. In other words, the subtitle descriptor 1310 may include subtitle service information 1320 about the first page 1350 of the subtitle data in the first PES packet 1340 having PID information X, and subtitle service information 1330 about the second page 1370 of the subtitle data in the second PES packet 1360 having PID information Y.

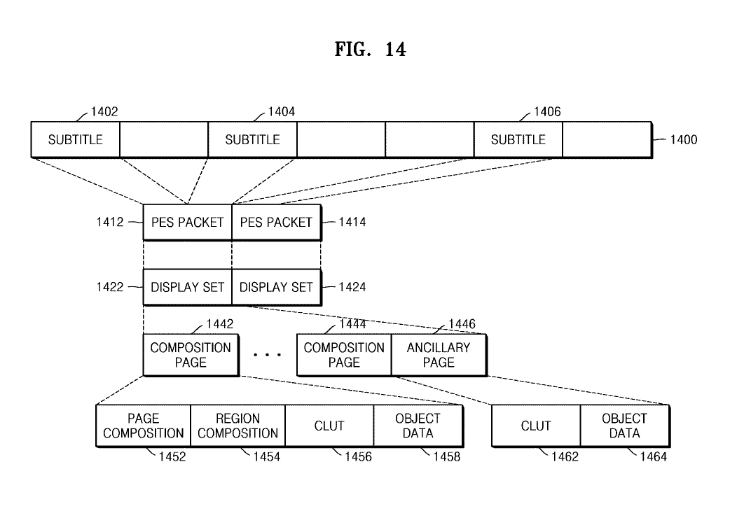

FIG. 14 is a diagram of a structure of a datastream including subtitle data complying with a DVB communication method, according to an embodiment.

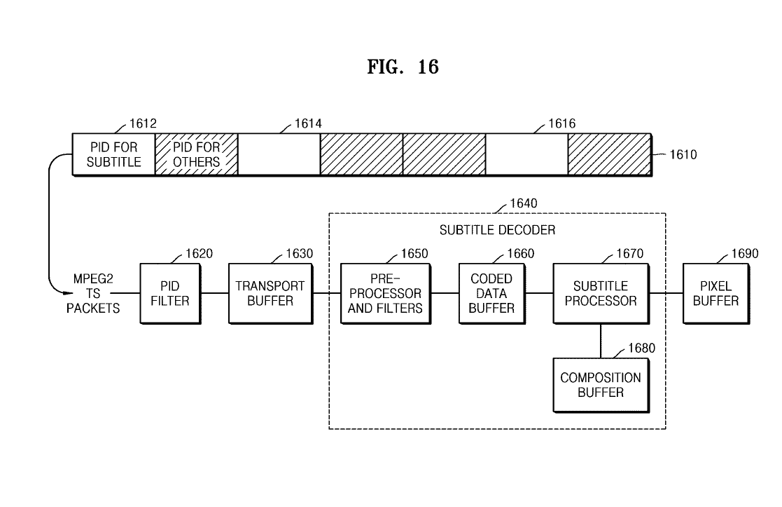

A subtitle decoder (e.g., subtitle decoder 1640 in FIG. 16) may form subtitle PES packets 1412 and 1414 by gathering subtitle TS packets 1402, 1404, and 1406 assigned with the same PID information, from a DVB TS 1400 including a subtitle complying with the DVB communication method. The subtitle TS packets 1402 and 1406, respectively forming starting parts of the subtitle PES packets 1412 and 1414, may be respectively headers of the subtitle PES packets 1412 and 1414.

The subtitle PES packets 1412 and 1414 may respectively include display sets 1422 and 1424, which are output units of a graphic object. The display set 1422 may include a plurality of composition pages 1442 and 1444, and an ancillary page 1446. The composition pages 1442 and 1444 may include composition information of a subtitle stream. The composition page 1442 may include a page composition segment 1452, a region composition segment 1454, a color lookup table (CLUT) definition segment 1456, and an object data segment 1458. The ancillary page 1446 may include a CLUT definition segment 1462 and an object data segment 1464.

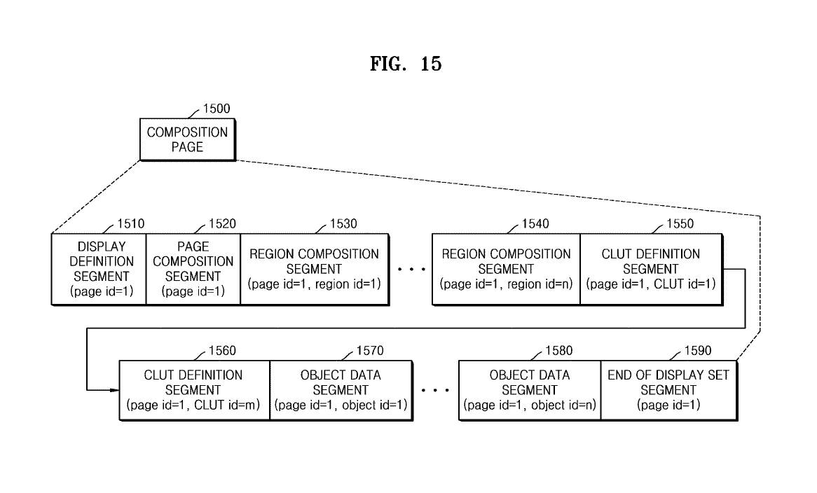

FIG. 15 is a diagram of a structure of a composition page 1500 complying with a DVB communication method, according to an embodiment.

The composition page 1500 may include a display definition segment 1510, a page composition segment 1520, region composition segments 1530 and 1540, CLUT definition segments 1550 and 1560, object data segments 1570 and 1580, and an end of display set segment 1590. The composition page 1500 may include a plurality of region composition segments, CLUT definition segments, and object data segments. All of the display definition segment 1510, the page composition segment 1520, the region composition segments 1530 and 1540, the CLUT definition segments 1550 and 1560, the object data segments 1570 and 1580, and the end of display set segment 1590 forming the composition page 1500, having a page identifier of 1, may have a page identifier (page id) of 1. Region identifiers (region id) of the region composition segments 1530 and 1540 may each be set to an index according to regions, and CLUT identifiers (CLUT id) of the CLUT definition segments 1550 and 1560 may each be set to an index according to CLUTs. Also, object identifiers (object id) of the object data segments 1570 and 1580 may each be set to an index according to object data.

Syntaxes of the display definition segment 1510, the page composition segment 1520, the region composition segments 1530 and 1540, the CLUT definition segments 1550 and 1560, the object data segments 1570 and 1580, and the end of display set segment 1590 may be encoded in subtitle segments and may be inserted into a payload region of a subtitle PES packet.

Table 1 shows a syntax of a “PES_data_field” field stored in a “PES_packet_data_bytes” field in a DVB subtitle PES packet. Subtitle data stored in the DVB subtitle PES packet may be encoded to be in a form of the “PES_data_field” field.

TABLE 1
Syntax

PES_data_field( ){

data_identifier
subtitle_stream_id
while nextbits( ) == ‘0000 1111’ {

subtitling_segment( )

}
end_of_PES_data_field_marker

}

A value of a “data_identifier” field may be fixed to 0x20 to show that current PES packet data is DVB subtitle data. A “subtitle stream id” field may include an identifier of a current subtitle stream, and may be fixed to 0x00. An “end_of_PES_data_field_marker” field may include information showing whether a current data field is a PES_data_field end field, and may be fixed to 1111 1111. A syntax of a “subtitling_segment” field is shown in Table 2 below.

TABLE 2
Syntax

subtitling_segment( ) {

sync_byte
segment_type
page_id
segment_length
segment_data_field( )

}

A “sync_byte” field may be encoded to 0000 1111. When a segment is decoded based on a value of a “segment_length” field, a “sync_byte” field may be used to determine a loss of a transmission packet by checking synchronization.

A “segment_type” field may include information about a type of data included in a segment data field.

Table 3 shows a segment type defined by a “segment_type” field.

TABLE 3

| Value | Segment Type |
|---|---|
| 0x10 | Page Composition Segment |
| 0x11 | Region Composition Segment |
| 0x12 | CLUT Definition Segment |
| 0x13 | Object Data Segment |
| 0x14 | Display Definition Segment |
| 0x40-0x7F | Reserved for Future Use |
| 0x80 | End of Display Set Segment |
| 0x81-0xEF | Private Data |
| 0xFF | Stuffing |
| All Other Values | Reserved for Future Use |

A “page_id” field may include an identifier of a subtitle service included in a “subtitling_segment” field. Subtitle data about one subtitle service may be included in a subtitle segment assigned with a value of “page_id” field that is set as a composition page identifier in a subtitle descriptor. Also, data that is shared by a plurality of subtitle services may be included in a subtitle segment assigned with a value of the “page_id” field that is set as an ancillary page identifier in the subtitle descriptor.

A “segment_length” field may include information about a number of bytes included in a “segment_data_field” field. The “segment_data_field” field may be a payload region of a segment, and a syntax of the payload region may differ according to a type of the segment. A syntax of payload region according to types of a segment is shown in Tables 4, 5, 7, 12, 13, and 15.

Table 4 shows a syntax of a “display_definition_segment” field.

TABLE 4
Syntax

display_definition_segment( ){

sync_byte
segment_type
page_id
segment_length
dds_version_number
display_window_flag
reserved
display_width
display_height
if (display_window_flag == 1) {

display_window_horizontal_position_minimum
display_window_horizontal_position_maximum
display_window_vertical_position_minimum
display_window_vertical_position_maximum

}

}

The display definition segment may define resolution of a subtitle service.

A “dds_version_number” field may include version information of the display definition segment. A version number constituting a value of the “dds_version_number” field may increase in a unit of modulo 16 whenever content of the display definition segment changes.

When a value of a “display window flag” field is set to “1”, a DVB subtitle display set related to the display definition segment may define a window region in which the subtitle is to be displayed, within a display size defined by a “display_width” field and a “display_height” field. For example, in the display definition segment, a size and a location of the window region may be defined according to values of a “display_window_horizontal_position_minimum” field, a “display_window_horizontal_position_ maximum” field, a “display_window_vertical_position_minimum” field, and a “display_window_vertical_position_maximum” field.

In response to the value of the “display_window_flag” field being set to “0”, the DVB subtitle display set may be expressed within a display defined by the “display_width” field and the “display_height” field, without a window region.

The “display_width” field and the “display_height” field may respectively include a maximum horizontal width and a maximum vertical height in a display, and values thereof may each be set in a range from 0 to 4095.

A “display_window_horizontal_position_minimum” field may include a horizontal minimum location of a window region in a display. The horizontal minimum location of the window region may be defined with a left end pixel value of a DVB subtitle display window based on a left end pixel of the display.

A “display_window_horizontal_position_maximum” field may include a horizontal maximum location of the window region in the display. The horizontal maximum location of the window region may be defined with a right end pixel value of the DVB subtitle display window based on a left end pixel of the display.

A “display_window_vertical_position_minimum” field may include a vertical minimum pixel location of the window region in the display. The vertical minimum pixel location may be defined with an uppermost line value of the DVB subtitle display window based on an upper line of the display.

A “display_window_vertical_position_maximum” field may include a vertical maximum pixel location of the window region in the display. The vertical maximum pixel location may be defined with a lowermost line value of the DVB subtitle display window based on the upper line of the display.

Table 5 shows a syntax of a “page_composition_segment” field.

TABLE 5
Syntax

Page_composition_segment( ){

sync_byte
segment_type
page_id
segment_length
page_time_out
page_version_number
page_state
reserved
while (processed_length < segment_length){

region_id
reserved
region_horizontal_address
region_vertical_address

}

)

A “page_time_out” field may include information about a period of time for a page to disappear from a screen since the page is not effective, and may be set in a unit of seconds. A value of a “page_version_number” field may denote a version number of a page composition segment, and may increase in a unit of modulo 16 whenever content of the page composition segment changes.

A “page_state” field may include information about a page state of a subtitle page instance described in the page composition segment. A value of the “page_state” field may denote a status of a decoder for displaying a subtitle page according to the page composition segment. Table 6 shows content of the value of the “page_state” field.

TABLE 6

| Value | Page State | Effect on Page | Comments |
|---|---|---|---|
| 00 | Normal | Page Update | Display set contains only subtitle |
| | Case | | elements that are changed from |
| | | | previous page instance |
| 01 | Acquisition | Page Refresh | Display set contains all subtitle |
| | Point | | elements needed to display next |
| | | | page instance |
| 10 | Mode | New Page | Display set contains all subtitle |
| | Change | | elements needed to display the |
| | | | new page |
| 11 | Reserved | | Reserved for future use |

A “processed_length” field may include information about a number of bytes included in a “while” loop to be processed by the decoder. A “region_id” field may indicate an intrinsic identifier about a region in a page. Each identified region may be displayed on a page instance defined in the page composition segment. Each region may be recorded in the page composition segment according to an ascending order of the value of a “region_vertical_address” field.

A “region_horizontal_address” field may define a location of a horizontal pixel to which an upper left pixel of a corresponding region in a page is to be displayed, and the “region_vertical_address” field may define a location of a vertical line to which the upper left pixel of the corresponding region in the page is to be displayed.

Table 7 shows a syntax of a “region_composition_segment” field.

TABLE 7
Syntax

Region_composition_segment( ){

sync_byte
segment_type
page_id
segment_length
region_id
region_version_number
region_fill_flag
reserved
region_width
region_height
region_level_of_compatibility
region_depth
reserved
CLUT_id
region_8-bit_pixel_code
region_4-bit_pixel-code
region_2-bit_pixel-code
reserved
while (processed_length < segment_length) {

object_id
object_type
object_provider_flag

object_horizontal_position

reserved
object_vertical_position
if (object_type ==0x01 or object_type == 0x02){

foreground_pixel_code
background_pixel_code

}

}

}

A “region_id” field may include an intrinsic identifier of a current region.

A “region_version_number” field may include version information of a current region. A version of the current region may increase in response to a value of a “region_fill_flag” field being set to “1”; in response to a CLUT of the current region being changed; or in response to a length of the current region being not “0”, but including an object list.

In response to a value of a “region_fill_flag” field being set to “1”, the background of the current region may be filled by a color defined in a “region_n-bit_pixel_code” field.

A “region_width” field and a “region height” field may respectively include horizontal width information and vertical height information of the current region, and may be set in a pixel unit. A “region_level_of_compatibility” field may include minimum CLUT type information required by a decoder to decode the current region, and may be defined according to Table 8.

TABLE 8

| Value | region_level_of_compatibility |
|---|---|
| 0x00 | Reserved |
| 0x01 | 2-bit/Entry CLUT Required |
| 0x02 | 4-bit/Entry CLUT Required |
| 0x03 | 8-bit/Entry CLUT Required |
| 0x04 . . . 0x07 | Reserved |

When the decoder is unable to support an assigned minimum CLUT type, the current region may not be displayed, even though other regions that require a lower level CLUT type may be displayed.

A “region_depth” field may include pixel depth information, and may be defined according to Table 9.

TABLE 9

| Value | region_depth |
|---|---|
| 0x00 | Reserved |
| 0x01 | 2 bits |
| 0x02 | 4 bits |
| 0x03 | 8 bits |
| 0x04 . . . 0x07 | Reserved |

A “CLUT_id” field may include an identifier of a CLUT to be applied to the current region. A value of a “region_{—}8-bit_pixel-code” field may define a color entry of an 8 bit CLUT to be applied as a background color of the current region, in response to a “region_fill_flag” field being set. Similarly, values of a “region_{—}4-bit_pixel-code” field and a “region_{—}2-bit_pixel-code” field may respectively define color entries of a 4 bit CLUT and a 2 bit CLUT, which are to be applied as the background color of the current region, I response to the “region_fill_flag” field being set.

An “object_id” field may include an identifier of an object in the current region, and an “object_type” field may include object type information defined in Table 10. An object type may be classified into a basic object or a composition object, a bitmap, a character, or a string of characters.

TABLE 10

| Value | object_type |
|---|---|
| 0x00 | basic_object, bitmap |
| 0x01 | basic_object, character |
| 0x02 | composite_object, string of characters |
| 0x03 | Reserved |

An “object_provider_flag” field may show a method of providing an object according to Table 11.

TABLE 11

| Value | object_provider_flag |
|---|---|
| 0x00 | Provided in subtitling stream |
| 0x01 | Provided by POM in IRD |
| 0x02 | Reserved |
| 0x03 | Reserved |

An “object_horizontal_position” field may include information about a location of a horizontal pixel on which an upper left pixel of a current object is to be displayed, as a relative location on which object data is to be displayed in a current region. In other words, a number of pixels of the upper left pixels of the current object may be defined based on a left end of the current region.

An “object_vertical_position” field may include information about a location of a vertical line on which the upper left pixel of the current object is to be displayed, as the relative location on which the object data is to be displayed in the current region. In other words, a number of pixels of an upper line of the current object may be defined based on the upper part of the current region.

A “foreground_pixel_code” field may include color entry information of an 8 bit CLUT selected as a foreground color of a character. A “background pixel code” field may include color entry information of an 8 bit CLUT selected as a background color of the character.

Table 12 shows a syntax of a “CLUT_definition_segment” field.

TABLE 12
Syntax

CLUT_definition_segment( ){

sync_byte
segment_type
page_id
segment length
CLUT-id
CLUT_version_number
reserved
while (processed_length < segment length) {

CLUT_entry_id
2-bit/entry_CLUT_flag
4-bit/entry_CLUT_flag
8-bit/entry_CLUT_flag
reserved
full_range_flag
if full_range_flag == ‘1’{

Y-value
Cr-value
Cb-value
T-value

} else {

Y-value
Cr-value
Cb-value
T-value

}

}

}

A “CLUT-id” field may include an identifier of a CLUT included in a CLUT definition segment in a page. A “CLUT_version_number” field denotes a version number of the CLUT definition segment, and the version number may increase in a unit of modulo 16 when content of the CLUT definition segment changes.

A “CLUT_entry_id” field may include an intrinsic identifier of a CLUT entry, and may have an initial identifier value of “0”. In response to a value of a “2-bit/entry_CLUT_flag” field being set to “1”, a current CLUT may be configured as a two (2) bit entry. Similarly, in response to a value of a “4-bit/entry_CLUT_flag” field or “8-bit/entry_CLUT_flag” field being set to “1”, the current CLUT may be configured as a four (4) bit entry or an eight (8) bit entry.

In response to a value of a “full_range_flag” field being set to “1”, full eight (8) bit resolution may be applied to a “Y_value” field, a “Cr_value” field, a “Cb_value” field, and a “T_value” field.

The “Y_value” field, the “Cr_value” field, and the “Cb_value” field may respectively include Y output information, Cr output information, and Cb output information of the CLUT for each input.

The “T_value” field may include transparency information of the CLUT for an input. When a value of the “T_value” field is 0, there may be no transparency.

Table 13 shows a syntax of a “object_data_segment” field.

TABLE 13
Syntax

object_data_segment( ) {

sync_byte
segment_type
page_id
segment_length
object_id
object_version_number
object_coding_method
non_modifying_colour_flag
reserved
if (object coding method == ‘00’) {

top_field_data_block_length
bottom_field_data_block_length
while(processed_length < top_field_data_block_length)

pixel-data_sub-block( )

while (processed_length< bottom_field_data_block_length)

pixel-data_sub-block( )

if (!wordaligned( ))

8_stuff_bits

}
if (object_coding_method == ‘01’) {

number_of_codes
for (i== 1; i<= number_of_codes; i++)

character_code

}

}

An “object_id” field may include an identifier about a current object in a page. An “object_version_number” field may include version information of a current object data segment, and the version number may increase in a unit of modulo 16 whenever content of the object data segment changes.

An “object_coding_method” field may include information about an encoding method of an object. The object may be encoded in a pixel or a string of characters as shown in Table 14.

TABLE 14

| Value | object_coding_method |
|---|---|
| 0x00 | Encoding of pixels |
| 0x01 | Encoded as a string of characters |
| 0x02 | Reserved |
| 0x03 | Reserved |

In response to a value of a “non_modifying_colour_flag” field being set to “1”, an input value 1 of the CLUT may be an “unchanged color”. In response to the unchanged color being assigned to an object pixel, a background or the object pixel in a basic region may not be changed.

A “top_field_data_block length” field may include information about a number of bytes included in a “pixel-data_sub-blocks” field with respect to an uppermost field. A “bottom_field_data_block length” field may include information about a number of bytes included in a “data_sub-block” with respect to a lowermost field. In each object, a pixel data sub block of the uppermost field and a pixel data sub block of the lowermost field may be defined by the same object data segment.

An “8_stuff_bits” field may be fixed to 0000 0000. A “number_of_codes” field may include information about a number of character codes in a string of characters. A value of a “character_code” field may set a character by using an index in a character code identified in the subtitle descriptor.

Table 15 shows a syntax of an “end_of_display_set_segment” field.

TABLE 15
Syntax

end_of_display_set_segment( ) {

sync_byte
segment_type
page_id
segment_length

}

The “end_of_display set_segment” field may be used to notify the decoder that transmission of a display set is completed. The “end_of_display_set_segment” field may be inserted after the last “object_data_segment” field for each display set. Also, the “end_of_display_set_segment” field may be used to classify each subtitle service in one subtitle stream.

FIG. 16 is a flowchart illustrating a subtitle processing model complying with a DVB communication method.

According to the subtitle processing model complying with the DVB communication method, a TS 1610 including subtitle data may be decomposed into MPEG-2 TS packets. A PID filter 1620 may only extract TS packets 1612, 1614, and 1616 for a subtitle assigned with PID information from among the MPEG-2 TS packets, and may transmit the extracted TS packets 1612, 1614, and 1616 to a transport buffer 1630. The transport buffer 1630 may form subtitle PES packets by using the TS packets 1612, 1614, and 1616. Each subtitle PES packet may include a PES payload including subtitle data, and a PES header. A subtitle decoder 1640 may receive the subtitle PES packets output from the transport buffer 1630, and may form a subtitle to be displayed on a screen.

The subtitle decoder 1640 may include a pre-processor and filters 1650, a coded data buffer 1660, a composition buffer 1680, and a subtitle processor 1670.

Presuming that a page having “page_id” field of “1” is selected from a PMT by a user, the pre-processor and filters 1650 may decompose composition pages having “page_id” field of “1” in the PES payload into display definition segments, page composition segments, region composition segments, CLUT definition segments, and object data segments. For example, at least one piece of object data in the at least one object data segment may be stored in the coded data buffer 1660, and the display definition segment, the page composition segment, the at least one region composition segment, and the at least one CLUT definition segment may be stored in the composition buffer 1680.

The subtitle processor 1670 may receive the at least one piece of object data from the coded data buffer 1660, and may generate the subtitle formed of at least one object based on the display definition segment, the page composition segment, the at least one region composition segment, and the at least one CLUT definition segment stored in the composition buffer 1680.

The subtitle decoder 1640 may draw the generated subtitle on a pixel buffer 1690.

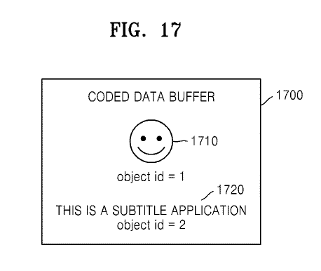

FIGS. 17 through 19 are diagrams illustrating data stored respectively in a coded data buffer 1700, a composition buffer 1800, and the pixel buffer 1690.

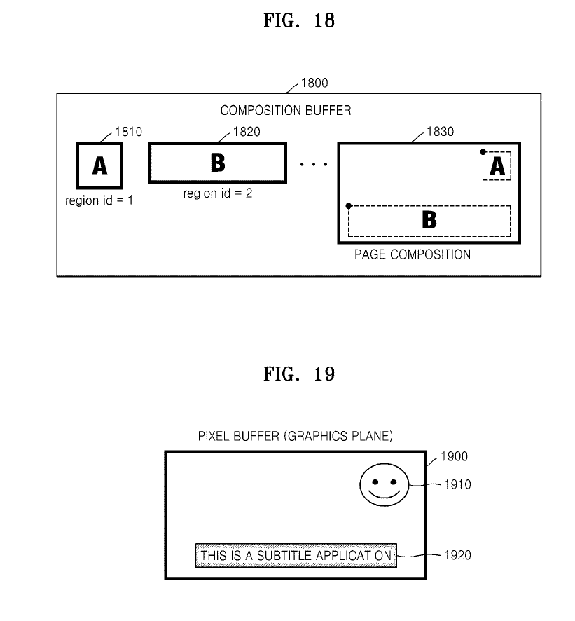

Referring to FIG. 17, object data 1710 having an object id of “1”, and object data 1720 having an object id of “2” may be stored in the coded data buffer 1700. Referring to FIG. 18, information about a first region 1810 having a region id of “1”, information about a second region 1820 having a region id of “2”, and information about a page composition 1830 formed of the first and second regions 1810 and 1820 may be stored in the composition buffer 1800.

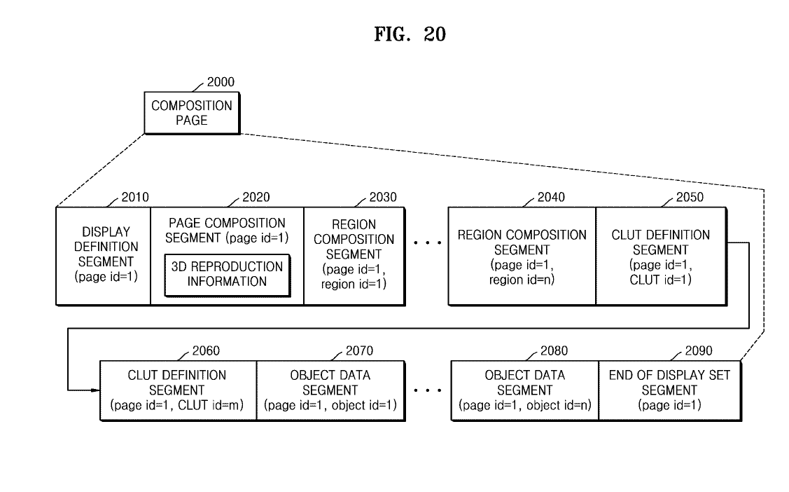

The subtitle processor 1670 of FIG. 17 may store a subtitle page 1900, in which subtitle objects 1910 and 1920 are disposed according to regions, as shown in FIG. 19 in the pixel buffer 1690 based on the object data 1710 and 1720 stored in the coded data buffer 1700, and the first region 1810, the second region 1820, and the page composition 1830 stored in the composition buffer 1800.

Operations of the apparatus 100 and the apparatus 200, according to another embodiment will now be described with reference to Tables 16 through 21 and FIGS. 20 through 23, based on the subtitle complying with the DVB communication method described with reference to Tables 1 through 15 and FIGS. 10 through 19.

The apparatus 100 according to an embodiment may insert information for reproducing a DVB subtitle in 3D into a subtitle PES packet. For example, the information may include offset information including at least one of a movement value, a depth value, disparity, and parallax of a region on which a subtitle is displayed, and an offset direction indicating a direction in which the offset information is applied.

FIG. 20 is a diagram of a structure of a composition page 2000 of subtitle data complying with a DVB communication method, according to an embodiment. Referring to FIG. 20, the composition page 2000 may include a display definition segment 2010, a page composition segment 2020, region composition segments 2030 and 2040, CLUT definition segments 2050 and 2060, object data segments 2070 and 2080, and an end of a display set segment 2090. In FIG. 20, the page composition segment 2020 may include 3D reproduction information according to an embodiment. The 3D reproduction information may include offset information including at least one of a movement value, a depth value, disparity, and parallax of a region on which a subtitle is displayed, and an offset direction indicating a direction in which the offset information is applied.

The program encoder 110 of the apparatus 100 may insert the 3D reproduction information for reproducing the subtitle in 3D into the page composition segment 2020 of the composition page 2000 in the subtitle PES packet.

Tables 16 and 17 show syntaxes of the page composition segment 2020 including the 3D reproduction information.

TABLE 16
Syntax

page_composition_segment( ){

sync_byte
segment_type
page_id
segment_length
page_time_out
page_version_number
page_state
reserved
while (processed_length < segment_length){

region_id
region_offset_direction
region_offset
region_horizontal_address
region_vertical_address

}

}

As shown in Table 16, the program encoder 110 according to an embodiment may additionally insert a “region_offset_direction” field and a “region_offset” field into the “reserved” field in a while loop in the “page_composition_segment( )” field of Table 5.

The program encoder 110 may assign one (1) bit of the offset direction to the “region_offset_direction” field and seven (1) bits of the offset information to the “region_offset” field in replacement of eight (8) bits of the “reserved” field.

TABLE 17
Syntax

page_composition_segment( ){

sync_byte
segment_type
page_id
segment_length
page_time_out
page_version_number
page_state
reserved
while (processed_length < segment_length){

region_id
region_offset_based_position
region_offset_direction
region_offset
region_horizontal_address
region_vertical_address

}

}

In Table 17, a “region_offset_based_position” field may be further added to the page composition segment of Table 16.

One bit of a “region_offset_direction” field, 6 bits of a “region_offset” field, and one bit of a “region offset_based_position” field may be assigned in replacement of eight bits of the “reserved” field in the page composition segment of Table 5.

The “region offset_based_position” field may include flag information indicating whether an offset value of the “region_offset” field is applied based on a zero plane or based on a depth or movement value of a video image.

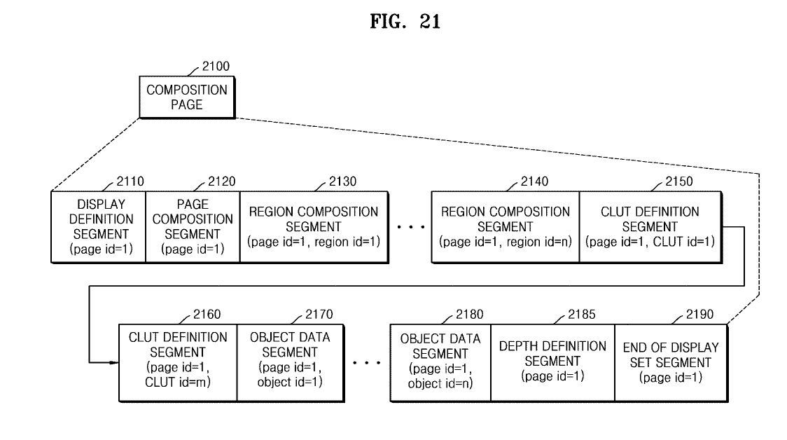

FIG. 21 is a diagram of a structure of a composition page 2100 of subtitle data complying with a DVB communication method, according to another embodiment. Referring to FIG. 12, the composition page 2100 may include a depth definition segment 2185 along with a display definition segment 2110, a page composition segment 2120, region composition segments 2130 and 2140, CLUT definition segments 2150 and 2160, object data segments 2170 and 2180, and end of display set segment 2190.

The depth definition segment 2185 may be a segment defining 3D reproduction information, and may include the 3D reproduction information including offset information for reproducing a subtitle in 3D. Accordingly, the program encoder 110 may newly define a segment for defining the depth of the subtitle and may insert the newly defined segment into a PES packet.

Tables 18 through 21 show syntaxes of a “Depth Definition Segment” field constituting the depth definition segment 2185, which is newly defined by the program encoder 110 to reproduce the subtitle in 3D.

The program encoder may insert the “Depth Definition Segment” field into the “segment_data_field” field in the “subtitling_segment” field of Table 2, as an additional segment. Accordingly, the program encoder 110 guarantees low-level compatibility with a DVB subtitle system by additionally defining the depth definition segment 2185 as a type of the subtitle, in a reversed region of a subtitle type field, wherein a value of the “subtitle_type” field of Table 3 is from “0x40” to “0x7F”.

The depth definition segment 2185 may include information defining the offset information of the subtitle in a page unit. Syntaxes of the “Depth Definition Segment” field may be shown in Tables 18 and 19.

TABLE 18
Syntax

Depth_Definition_Segment( ) {

sync_byte
segment_type
page_id
segment_length
page_offset_direction
page_offset

......

TABLE 19
Syntax

Depth_Definition_Segment( ) {

sync_byte
segment_type
page_id
segment_length
page_offset_based_position
page_offset_direction
page_offset

......

A “page_offset_direction” field in Tables 18 and 19 may indicate the offset direction in which the offset information is applied in a current page. A “page_offset” field may indicate the offset information, such as a movement value of a pixel in the current page, a depth value, disparity, and parallax.

The program encoder 110 may include a “page_offset_based_position” field in the depth definition segment. The “page_offset_based_position” field may include flag information indicating whether an offset value of the “page_offset” field is applied based on a zero plane or based on offset information of a video image.

According to the depth definition segment of Table 18 and 19, the same offset information may be applied in one page.

The apparatus 100 according to an embodiment may newly generate a depth definition segment defining the offset information of the subtitle in a region unit, with respect to each region included in the page. For example, syntaxes of a “Depth Definition Segment” field may be as shown in Tables 20 and 21.

TABLE 20
Syntax

Depth_Definition_Segment( ) {

sync_byte
segment_type
page_id
segment_length
for (i=0; i<N; i++){

region_id
region_offset_direction
region_offset

}

......

TABLE 21
Syntax

Depth_Definition_Segment( ) {

sync_byte
segment_type
page_id
segment_length
for (i=0; i<N; i++){

region_id
region_offset_based_position
region_offset_direction
region_offset

}

......

A “page_id” field and a “region_id” field in the depth definition segment of Tables 20 and 21 may refer to the same fields in the page composition segment. The apparatus 100 according to an embodiment may set the offset information of the subtitle according to regions in the page, through a for loop in the newly defined depth definition segment. In other words, the “region_id” field may include identification information of a current region; and a “region_offset_direction” field, a “region_offset” field, and a “region_offset_based_position” field may be separately set according to a value of the “region_id” field. Accordingly, the movement amount of the pixel in an x-coordinate may be separately set according to regions of the subtitle.

The apparatus 200 according to an embodiment may extract composition pages by parsing a received TS, and form a subtitle by decoding syntaxes of a page composition segment, a region definition segment, a CLUT definition segment, an object data segment, etc. in the composition pages. Also, the apparatus 200 may adjust depth of a page or a region on which the subtitle is displayed by using the 3D reproduction information described above with reference to Tables 13 through 21.

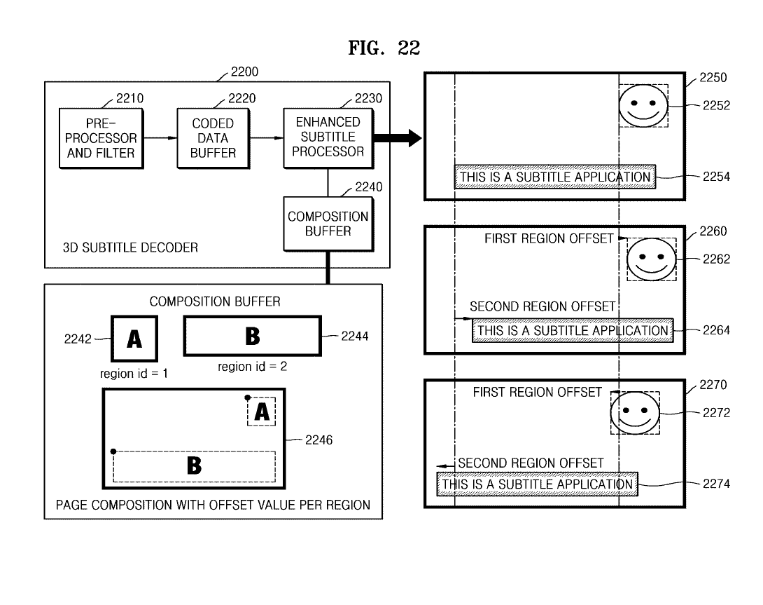

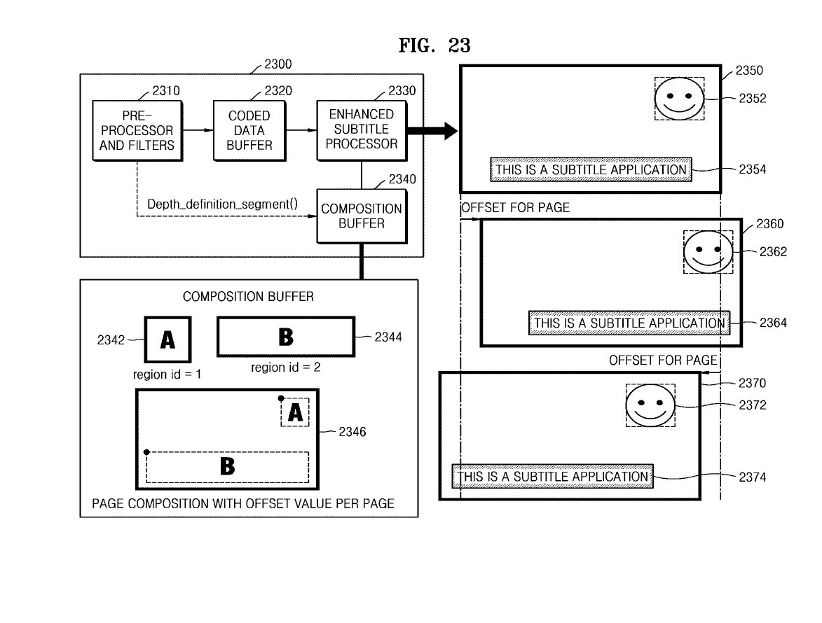

A method of adjusting depth of a page and a region of a subtitle will now be described with reference to FIGS. 22 and 23.

FIG. 22 is a diagram for describing adjusting of the depth of a subtitle according to regions, according to an embodiment.

A subtitle decoder 2200 according to an embodiment may be realized by modifying the subtitle decoder 1640 of FIG. 16, which may be the subtitle processing model complying with a DVB communication method.

The subtitle decoder 2200 may include a pre-processor and filters 2210, a coded data buffer 2220, an enhanced subtitle processor 2230, and a composition buffer 2240. The pre-processor and filters 2210 may transmit object data in a subtitle PES payload to the coded data buffer 220, and may transmit subtitle composition information, such as a region definition segment, a CLUT definition segment, a page composition segment, and an object data segment, to the composition buffer 2240. According to an embodiment, the depth information according to regions shown in Tables 16 and 17 may be included in the page composition segment.

For example, the composition buffer 2240 may include information about a first region 2242 having a region id of “1”, information about a second region 2244 having a region id of “2”, and information about a page composition 2246 including an offset value per region.

The enhanced subtitle processor 2230 may form a subtitle page by using the object data stored in the coded data buffer 2220 and the composition information stored in the composition buffer 2240. For example, in a 2D subtitle page 2250, a first object and a second object may be respectively displayed on a first region 2252 and a second region 2254.

The enhanced subtitle processor 2230 may adjust the depth of regions on which the subtitle is displayed by moving each region according to offset information. In other words, the enhanced subtitle processor 2230 may move the first and second regions 2252 and 2254 by a corresponding offset based on the offset information according to regions, in the page composition 2246 stored in the composition buffer 2240. The enhanced subtitle processor 2230 may generate a left-eye subtitle 2260 by moving the first and second regions 2252 and 2254 in a first direction respectively by a first region offset and a second region offset such that the first and second regions 2252 and 2254 are displayed respectively on a first left-eye region 2262 and a second left-eye region 2264. Similarly, the enhanced subtitle processor 2230 may generate a right-eye subtitle 2270 by moving the first and second regions 2252 and 2254 in an opposite direction to the first direction respectively by the first region offset and the second region offset such that the first and second regions 2252 and 2254 are displayed respectively on a first right-eye region 2272 and a second right-eye region 2274.

FIG. 23 is a diagram for describing adjusting of the depth of a subtitle according to pages, according to an embodiment.

A subtitle processor 2300 according to an embodiment may include a pre-processor and filters 2310, a coded data buffer 2320, an enhanced subtitle processor 2330, and a composition buffer 2340. The pre-processor and filters 2310 may transmit object data in a subtitle PES payload to the coded data buffer 2320, and may transmit subtitle composition information, such as a region definition segment, a CLUT definition segment, a page composition segment, and an object data segment, to the composition buffer 2340. According to an embodiment, the pre-processor and filters 2310 may transmit depth information according to pages or according to regions of the depth definition segment shown in Tables 18 through 21 to the composition buffer 2340.

For example, the composition buffer 2340 may store information about a first region 2342 having a region id of “1”, information about a second region 2344 having a region id of “2”, and information about a page composition 2346 including an offset value per page of the depth definition segment shown in Tables 18 and 19.

The enhanced subtitle processor 2330 may adjust all subtitles in a subtitle page to have the same depth by forming the subtitle page and moving the subtitle page according to the offset value per page, by using the object data stored in the coded data buffer 2320 and the composition information stored in the composition buffer 2340.

Referring to FIG. 23, a first object and a second object may be respectively displayed on a first region 2352 and a second region 2354 of a 2D subtitle page 2350. The enhanced subtitle processor 2330 may generate a left-eye subtitle 2360 and a right-eye subtitle 2370 by respectively moving the first region 2252 and the second region 2254 by a corresponding offset value, based on the page composition 2346 with the offset value per page stored in the composition buffer 2340. In order to generate the left-eye subtitle 2360, the enhanced subtitle processor 2330 may move the 2D subtitle page 2350 by a current offset for page in a right direction from a current location of the 2D subtitle page 2350. Accordingly, the first and second regions 2352 and 2354 may also move by the current offset for page in a positive x-axis direction, and thus the first and second objects may be respectively displayed in a first left-eye region 2362 and a second left-eye region 2364.

Similarly, in order to generate the right-eye subtitle 2370, the enhanced subtitle processor 2330 may move the 2D subtitle page 2350 by the current offset for page in a left direction from the current location of the 2D subtitle page 2350. Accordingly, the first and second regions 2352 and 2354 may also move to a negative x-axis direction by the current offset for page, and thus the first and second objects may be respectively displayed on a first right-eye region 2372 and a second right-eye region 2374.

Also, when the offset information according to regions stored in the depth definition segment shown in Tables 20 and 21 is stored in the composition buffer 2340, the enhanced subtitle processor 2330 may generate a subtitle page applied with the offset information according to regions, generating results similar to the left-eye subtitle 2260 and the right-eye subtitle 2270 of FIG. 22.

The apparatus 100 may insert and transmit 3D reproduction information for reproducing subtitle data and a subtitle in 3D into a DVB subtitle PES packet. Accordingly, the apparatus 200 may receive a datastream of multimedia received according to a DVB method, extract the subtitle data and the 3D reproduction information form the datastream, and form a 3D DVB subtitle by using the subtitle data and the 3D reproduction information. Also, the apparatus 200 may adjust depth between a 3D video and a 3D subtitle based on the DVB subtitle and the 3D reproduction information to a prevent a viewer from being fatigued due to a depth reverse phenomenon between the 3D video and the 3D subtitle. Accordingly, the viewer may view the 3D video under stable conditions.

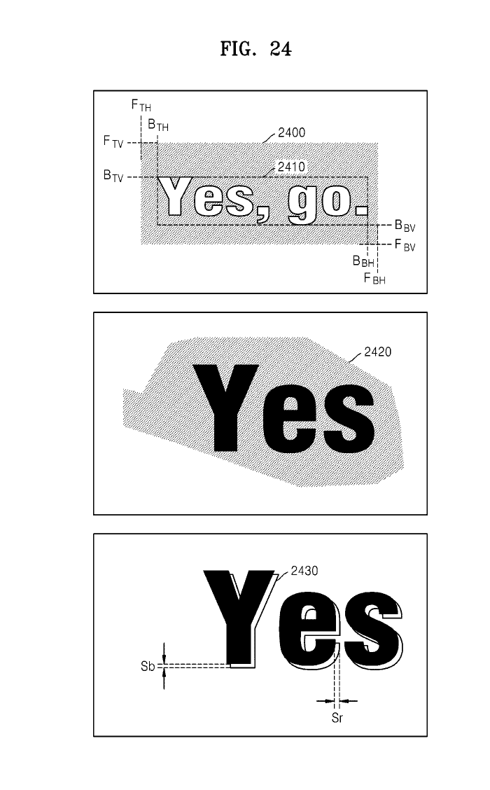

Generating and receiving of a multimedia stream for reproducing a subtitle in 3D, according to a cable broadcasting method, according to an embodiment, will now be described with reference to Tables 22 through 35 and FIGS. 24 through 30.

Table 22 shows a syntax of a subtitle message table according to a cable broadcasting method.

TABLE 22
Syntax

subtitle_message( ){

table_ID
zero
ISO reserved
section_length
zero
segmentation_overlay_included
protocol_version
if (segmentation_overlay_included) {

table_extension
last_segment_number
segment_number

}
ISO_639_language_code
pre_clear_display
immediate
reserved
display_standard
display_in_PTS
subtitle_type
reserved
display_duration
block_length
if (subtitle_type==simple_bitmap) {

simple_bitmap( )

} else {

reserved( )

}
for (i=0; i<N; i++) {

descriptor( )

}
CRC_32

}

A “table_ID” field may include a table identifier of a current “subtitle_message” table.

A “section_length” field may include information about a number of bytes from a “section_length” field to a “CRC_{—}32” field. A maximum length of the “subtitle_message” table from the “table_ID” field to the “CRC_{—}32” field may be, for example, one (1) kilobyte, e.g., 1024 bytes. When a size of the “subtitle_message” table exceeds 1 kilobyte due to a size of a “simple_bitmap( )” field, the “subtitle_message” table may be divided into a segment structure. A size of each divided “subtitle_message” table is fixed to 1 kilobyte, and remaining bytes of a last “subtitle_message” table that is not 1 kilobyte may be filled by a stuffing descriptor. Table 23 shows a syntax of a “stuffing_descriptor( )” field.

TABLE 23
Syntax

stuffing_descriptor( ) {

descriptor_tag
stuffing_string_length
stuffing_string

}

A “stuffing_string_length” field may include information about a length of a stuffing string. A “stuffing_string” field may include the stuffing string and may not be decoded by a decoder.

In the “subtitle_message” table of Table 22, a “simple_bitmap( )” field from a “ISO_{—}639_language_code” field may be formed of a “message_body( )” segment. When a “descriptor( )” field selectively exists in a “subtitle_message” table, the “message_body( )” segment may include from the “ISO_{—}639_language_code” field to a “descriptor( )” field. The total length of the “message_body( )” segments may be, e.g., four (4) megabytes.

A “segmentation_overlay_included” field of the “subtitle_message( )” table of Table 22 may include information about whether the “subtitle_message( )” table is formed of segments. A “table_extension” field may include intrinsic information assigned for the decoder to identify “message_body( )” segments. A “last_segment_number” field may include identification information of a last segment for completing an entire message image of a subtitle. A “segment_number” field may include an identification number of a current segment. The identification number may be assigned with a number, e.g., from 0 to 4095.

A “protocol_version” field of the “subtitle_message( )” table of Table 22 may include information about an existing protocol version and a new protocol version when a basic structure changes. An “ISO_{—}639_language_code” field may include information about a language code complying with a predetermined standard. A “pre_clear_disply” field may include information about whether an entire screen is to be processed transparently before reproducing the subtitle. An “immediate” field may include information about whether to reproduce the subtitle on a screen at a point of time according to a “display_in_PTS” field or when immediately received.

A “display_standard” field may include information about a display standard for reproducing the subtitle. Table 24 shows content of the “display standard” field.

TABLE 24

| display_standard | | Meaning |
|---|---|---|
| 0 | _720_480_30 | Indicates that display standard has 720 |
| | | active display samples horizontally per line, |
| | | 480 active raster lines vertically, and runs |
| | | at 29.97 or 30 frames per second. |
| 1 | _720_576_25 | Indicates that display standard has 720 active |
| | | display samples horizontally per line, 576 |
| | | active raster lines vertically, and runs at 25 |
| | | frames per second. |
| 2 | _1280_720_60 | Indicates that display standard has 1280 active |
| | | display samples horizontally per line, 720 |
| | | active raster lines vertically, and runs at 59.94 |
| | | or 60 frames per second. |
| 3 | _1920_1080_60 | Indicates that display standard has 1920 active |
| | | display samples horizontally per line, 1080 |
| | | active raster lines vertically, and runs at 59.94 |
| | | or 60 frames per second. |

| | |
|---|---|
| Other Values | Reserved |

In other words, it may be determined which display standard from among “resolution 720×480 and 30 frames per second”, “resolution 720×576 and 25 frames per second”, “resolution 1280×720 and 60 frames per second”, and “resolution 1920×1080 and 60 frames per second” is suitable for a subtitle, according to the “display_standard” field.

A “display_in_PTS” field of the “subtitle_message( )” of Table 22 may include information about a program reference time when the subtitle is to be reproduced. Time information according to such an absolute expressing method is referred to as an “in-cue time.” When the subtitle is to be immediately reproduced on a screen based on the “immediate” field, e.g., when a value of the “immediate” field is set to “1”, the decoder may not use a value of a “display_in_PTS” field.

When the “subtitle_message( )” table which has the in-cue time information and is to be reproduced after the “subtitle_message( )” table is received by the decoder, the decoder may discard a subtitle message that is on standby to be reproduced. In response to the value of the “immediate” field being set to “1”, all subtitle messages that are on standby to be reproduced may be discarded. If a discontinuous phenomenon occurs in PCR information for a service due to the decoder, all subtitle messages that are on standby to be reproduced may be discarded.

A “display_duration” field may include information about duration of the subtitle message to be displayed, wherein the duration is indicated in a frame number of a TV. Accordingly, a value of the “display_duration” field may be related to a frame rate defined in the “display_standard” field. An out-cue time obtained by adding the duration and the in-cue time may be determined according to the duration of the “display_duration” field. When the out-cue time is reached, a subtitle bitmap displayed on a screen time during the in-cue time may be erased.

A “subtitle_type” field may include information about a format of subtitle data. According to Table 25, the subtitle data has a simple bitmap format when a value of the “subtitle_type” field is “1”.

TABLE 25

| subtitle_type | Meaning |
|---|---|
| 0 | reserved |
| 1 | simple_bitmap - Indicates the subtitle data block |
| | contains data formatted in the simple bitmap style. |
| 2-15 | reserved |

A “block length” field may include information about a length of a “simple_bitmap( )” field or a “reserved( )” field.

The “simple_bitmap( )” field may include information about a bitmap format. A structure of the bitmap format will now be described with reference to FIG. 24.

FIG. 24 is a diagram illustrating components of the bitmap format of a subtitle complying with a cable broadcasting method.

The subtitle having the bitmap format may include at least one compressed bitmap image. Each compressed bitmap image may selectively have a rectangular background frame. For example, a first bitmap 2410 may have a background frame 2400. When a reference point (0,0) of a coordinate system is set to an upper left of a screen, the following four relations may be set between coordinates of the first bitmap 2410 and coordinates of the background frame 2400.

1. An upper horizontal coordinate value (F_{TH}) of the background frame 2400 is smaller or equal to an upper horizontal coordinate value (B_{TH}) of the first bitmap 2410 (F_{TH}≦B_{TH}).

2. An upper vertical coordinate value (F_{TH}) of the background frame 2400 is smaller or equal to an upper vertical coordinate value (B_{TV}) of the first bitmap 2410 (F_{TV}≧B_{TV}).

3. A lower horizontal coordinate value (F_{BH}) of the background frame 2400 is higher or equal to a lower horizontal coordinate value (B_{BH}) of the first bitmap 2410 (F_{BH}≧B_{BH}).

4. A lower vertical coordinate value (F_{BV}) of the background frame 2400 is higher or equal to a lower vertical coordinate value (B_{BV}) of the first bitmap 2410 (F_{BV}≧B_{BV}).

The subtitle having the bitmap format may have an outline 2420 and a drop shadow 2430. A thickness of the outline 2420 may be in the range from, e.g., 0 to 15. The drop shadow 2430 may include a right shadow (Sr) and a bottom shadow (Sb), where thicknesses of the right shadow Sr and the bottom shadow Sb are each in the range from, e.g., 0 to 15.

Table 26 shows a syntax of a “simple_bitmap( )” field.

TABLE 26
Syntax

simple_bitmap( ){

reserved
background_style
outline_style
character_color( )
bitmap_top_H_coordinate
bitmap_top_V_Coordinate
bitmap_bottom_H_coordinate
bitmap_bottom_V_coordinate
if (background_style ==framed){

frame_top_H_coordinate
frame_top_V_coordinate
frame_bottom_H_coordinate
frame_bottom_V_coordinate
frame_color( )

}
if (outline_style==outlined){

reserved
outline_thickness
outline_color( )

} else if (outline_style==drop_shadow){
shadow_right
shadow_bottom
shadow_color( )
} else if (outline_style==reserved){

reserved

}
bitmap_length
compressed_bitmap( )

}

Coordinates (bitmap_top_H_coordinate, bitmap_top_V_coordinate, bitmap_bottom_H_coordinate, and bitmap_bottom_V_coordinate) of a bitmap may be set in a “simple_bitmap( )” field.

Also, if a background frame exists based on a “background_style” field, coordinates (frame_top_H_coordinate, frame_top_V_coordinate, frame_bottom_H coordinate, and frame_bottom V_coordinate) of a background frame may be set in the “simple_bitmap( )” field.

Also, if an outline exists based on an “outline_style” field, a thickness (outline_thickness) of the outline may be set in the “simple_bitmap( )” field. Also, when a drop shadow exists based on the “outline_style” field, thicknesses (shadow_right, shadow_bottom) of a right shadow and a bottom shadow of the drop shadow may be set.

The “simple_bitmap( )” field may include a “character_color( )” field, which includes information about a color of a subtitle character, a “frame_color( )” field, which may include information about a color of the background frame of the subtitle, an “outline_color( )” field, which may include information about a color of the outline of the subtitle, and a “shadow_color( )” field including information about a color of the drop shadow of the subtitle. The subtitle character may indicate a subtitle displayed in a bitmap image, and a frame may indicate a region where the subtitle, e.g., a character, is output.

Table 27 shows a syntax of various “color( )” fields.

TABLE 27
Syntax

color( ){

Y_component
opaque_enable
Cr_component
Cb_component

}

A maximum of 16 colors may be displayed on one screen to reproduce the subtitle. Color information may be set according to color elements of Y, Cr, and Cb, (luminance and chrominance) and a color code may be determined in the range from, e.g., 0 to 31.

An “opaque_enable” field may include information about transparency of color of the subtitle. The color of the subtitle may be opaque or blended 50:50 with a color of a video image, based on the “opaque_enable” field. Other transparencies and translucencies are contemplated.

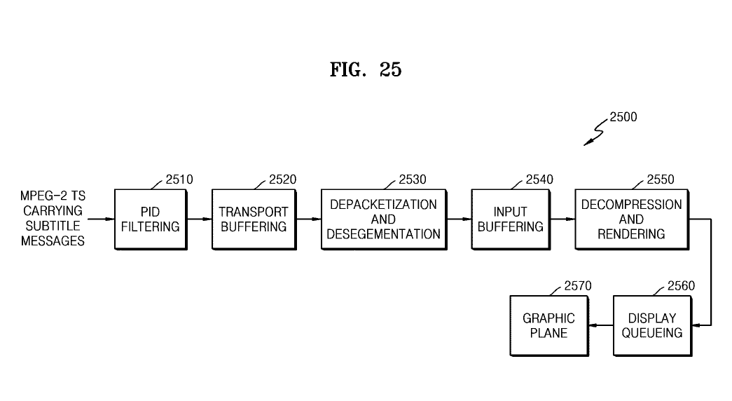

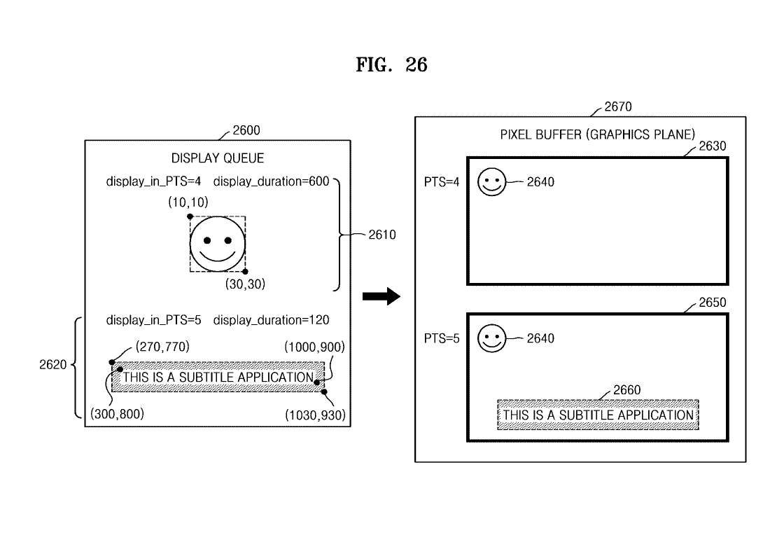

FIG. 25 is a flowchart of a subtitle processing model 2500 for 3D reproduction of a subtitle complying with a cable broadcasting method, according to an embodiment.

According to the subtitle processing model 2500, TS packets including subtitle messages may be gathered from an MPEG-2 TS carrying subtitle messages, and the TS packets may be output to a transport buffer, in operation 2510. The TS packets including subtitle segments may be stored in operation 2520.

The subtitle segments may be extracted from the TS packets in operation 2530, and the subtitle segments may be stored and gathered in operation 2540. Subtitle data may be restored and rendered from the subtitle segments in operation 2550, and the rendered subtitle data and information related to reproducing of a subtitle may be stored in a display queue in operation 2560.

The subtitle data stored in the display queue may form a subtitle in a predetermined region of a screen based on the information related to reproducing of the subtitle, and the subtitle may move to a graphic plane 2570 of a display device, such as a TV, at a predetermined point of time. Accordingly, the display device may reproduce the subtitle with a video image.

FIG. 26 is a diagram for describing a process of a subtitle being output from a display queue 2600 to a graphic plane through a subtitle processing model complying with a cable broadcasting method.

First bitmap data and reproduction related information 2610 and second bitmap data and reproduction related information 2620 may be stored in the display queue 2600 according to subtitle messages. For example, reproduction related information may include start time information (display_in_PTS) about a point of time when a bitmap is displayed on a screen, duration information (display_duration), and bitmap coordinates information. The bitmap coordinates information may include a coordinate of an upper left pixel of the bitmap and a coordinate of a bottom right pixel of the bitmap.

The subtitle formed based on the first bitmap data and reproduction related information 2610 and the second bitmap data and reproduction related information 2620 stored in the display queue 2600 may be stored in a pixel buffer (graphic plane) 2670, according to time information based on reproduction information. For example, a subtitle 2630, in which the first bitmap data is displayed on a location 2640 of corresponding coordinates when presentation time stamp (PTS) is “4” may be stored in the pixel buffer 2670, based on the first bitmap data and reproduction related information 2610 and the second bitmap data and reproduction related information 2620. Alternatively, when PTS is “5”, a subtitle 2650, in which the first bitmap data is displayed on the location 2640 and the second bitmap data is displayed on a location 2660 of corresponding coordinates, may be stored in the pixel buffer 2670.

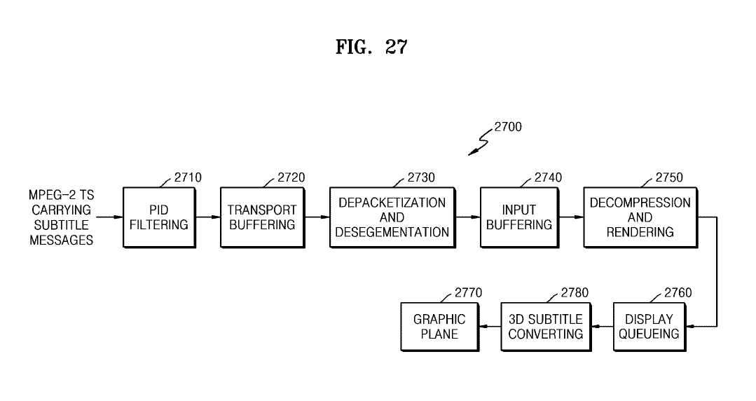

Operations of the apparatus 100 and the apparatus 200, according to another embodiment will now be described with reference to Tables 28 through 35 and FIGS. 27 through 30, based on the subtitle complying with the cable broadcasting method described with reference to Tables 22 through 27 and FIGS. 24 through 26.

The apparatus 100 according to an embodiment may insert information for reproducing a cable subtitle in 3D into a subtitle PES packet. For example, the information may include offset information including at least one of a movement value, a depth value, disparity, and parallax of a region on which a subtitle is displayed, and an offset direction indicating a direction in which the offset information is applied.

Also, the apparatus 200 according to an embodiment may gather subtitle PES packets having the same PID information from the TS received according to the cable broadcasting method. The apparatus 200 may extract 3D reproduction information from the subtitle PES packet, and change and reproduce a 2D subtitle into a 3D subtitle by using the 3D reproduction information.

FIG. 27 is a flowchart of a subtitle processing model 2700 for 3D reproduction of a subtitle complying with a cable broadcasting method, according to another embodiment.

Processes of restoring subtitle data and information related to reproducing a subtitle complying with the cable broadcasting method through operations 2710 through 2760 of the subtitle processing model 2700 are similar to operations 2510 through 2560 of the subtitle processing model 2500 of FIG. 25, except that 3D reproduction information of the subtitle may be additionally stored in a display queue in operation 2760.

In operation 2780, a 3D subtitle that is reproduced in 3D may be formed based on the subtitle data and the information related to reproducing of the subtitle stored in operation 2760. The 3D subtitle may be output to a graphic plane 2770 of a display device.

The subtitle processing model 2700 according to an embodiment may be applied to realize a subtitle processing operation of the apparatus 200. For example, operation 2780 may correspond to a 3D subtitle processing operation of the reproducer 240.

Hereinafter, operations of the apparatus 100 for transmitting 3D reproduction information of a subtitle, and operations of the apparatus 200 for reproducing the subtitle in 3D by using the 3D reproduction information will now be described in detail.

The program encoder 110 of the apparatus 100 may insert the 3D reproduction information into a “subtitle_message( )” field in a subtitle PES packet.

Also, the program encoder 110 may newly define a descriptor or a subtitle type for defining the depth of the subtitle, and may insert the descriptor or subtitle type into the subtitle PES packet.

Tables 28 and 29 respectively show syntaxes of a “simple_bitmap( )” field and a “subtitle_message( )” field, which may be modified by the program encoder 110 to include depth information of a cable subtitle.

TABLE 28
Syntax

simple_bitmap( ){

3d_subtitle_offset
background_style
outline_style
character_color( )
bitmap_top_H_coordinate
bitmap_top_V_Coordinate
bitmap_bottom_H_coordinate
bitmap_bottom_V_coordinate
if (background_style ==framed ){

frame_top_H_coordinate

frame_top_V_coordinate
frame_bottom_H_coordinate
frame_bottom_V_coordinate
frame_color( )
}
if (outline_style==outlined){

reserved
outline_thickness
outline_color( )

} else if (outline_style==drop_shadow){

shadow_right
shadow_bottom
shadow_color( )

} else if (outline_style==reserved){

reserved

}
bitmap_length
compressed_bitmap( )

}

As shown in Table 28, the program encoder 110 may insert a “3d_subtitle_offset” field into a “reserved( )” field in a “simple_bitmap( )” field of Table 26. In order to generate bitmaps for a left-eye subtitle and a right-eye subtitle for 3D reproduction, the “3d_subtitle_offset” field may include offset information including a movement amount for moving the bitmaps based on a horizontal coordinate axis. An offset value of the “3d_subtitle_offset” field may be applied equally to a subtitle character and a frame. Applying the offset value to the subtitle character means that the offset value is applied to a minimum rectangular region including a subtitle, and applying the offset value to the frame means that the offset value is applied to a region larger than a character region including the minimum rectangular region including the subtitle.

TABLE 29
Syntax

subtitle_message( ){

table_ID
zero
ISO reserved
section_length
zero
segmentation_overlay_included
protocol_version
if (segmentation_overlay_included) {

table_extension
last_segment_number
segment_number

}
ISO_639_language_code
pre_clear_display
immediate
reserved
display_standard
display_in_PTS
subtitle_type
3d_subtitle_direction
display_duration
block_length
if (subtitle_type==simple_bitmap) {

simple_bitmap( )

} else {

reserved( )

}
for (i=0; i<N; i++) {

descriptor( )

}
CRC_32

}

The program encoder 110 may insert a “3d_subtitle_direction” field into the “reserved( )” field in the “subtitle_message( )” field of Table 22. The “3d_subtitle_direction” field denotes an offset direction indicating a direction in which the offset information is applied to reproduce the subtitle in 3D.

The reproducer 240 may generate a right-eye subtitle by applying the offset information on a left-eye subtitle by using the offset direction. The offset direction may be negative or positive, or left or right. In response to a value of the “3d_subtitle_direction” field being negative, the reproducer 240 may determine an x-coordinate value of the right-eye subtitle by subtracting an offset value from an x-coordinate value of the left-eye subtitle. Similarly, in response to the value of the “3d_subtitle_direction” field being positive, the reproducer 240 may determine the x-coordinate value of the right-eye subtitle by adding the offset value to the x-coordinate value of the left-eye subtitle.

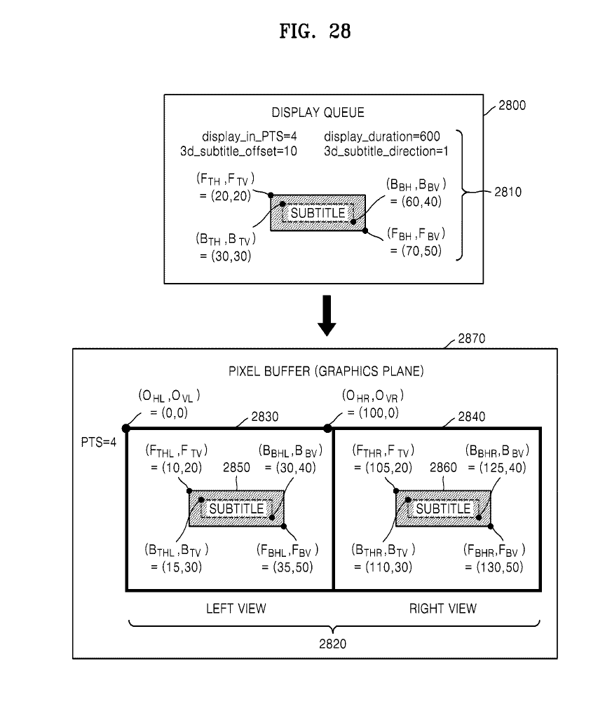

FIG. 28 is a diagram for describing adjusting of depth of a subtitle complying with a cable broadcasting method, according to an embodiment.

The apparatus 200 according to an embodiment receives a TS including a subtitle message, and extracts subtitle data from a subtitle PES packet by demultiplexing the TS.

The apparatus 200 may extract information about bitmap coordinates of the subtitle, information about frame coordinates, and bitmap data from the bitmap field of Table 28. Also, the apparatus 200 may extract the 3D reproduction information from the “3d_subtitle_offset”, which may be a lower field of the simple bitmap field of Table 28.

The apparatus 200 may extract information related to reproduction time of the subtitle from the subtitle message table of Table 29, and may extract the offset direction from the “3d_subtitle_offset_direction” field, which may be a lower field of the subtitle message table.

A display queue 2800 may store a subtitle information set 2810, which may include the information related to reproduction time of the subtitle (display_in_PTS and display_duration), the offset information (3d_subtitle_offset), the offset direction (3d_subtitle_direction), information related to subtitle reproduction including bitmap coordinates information (B_{TH}, B_{TV}, B_{BH}, and B_{BV}) of the subtitle and background frame coordinates information (F_{TH}, F_{TV}, F_{BH}, and F_{BV}) of the subtitle, and the subtitle data.

Through operation 2780 of FIG. 27, the reproducer 240 may form a composition screen in which the subtitle is disposed, and may store the composition screen in a pixel buffer (graphic plane) 2870, based on the information related to the subtitle reproduction stored in the display queue 2800.

A 3D subtitle plane 2820 of a side by side format, e.g., a 3D composition format, may be stored in the pixel buffer 2870. As resolution of the side by side format may be reduced by half along an x-axis, the x-axis coordinate value for a reference view subtitle and the offset value of the subtitle, from among the information related to the subtitle reproduction stored in the display queue 2800, may be halved to generate the 3D subtitle plane 2820. Y-coordinate values of a left-eye subtitle 2850 and a right-eye subtitle 2860 are identical to y-coordinate values of the subtitle from among the information related to the subtitle reproduction stored in the display queue 2800.

For example, it may be presumed that the display queue 2800 stores “display_in_PTS=4” and “display_duration=600” as the information related to a reproduction time of the subtitle, “3d_subtitle_offset=10” as the offset information, “3d_subtitle_direction=1” as the offset direction, “(B_{TH}, B_{TV})=(30, 30)” and “(B_{BH}, B_{BV})=(60, 40)” as the bitmap coordinates information, and “(F_{TH}, F_{TV})=(14, 20)” and “(F_{BH}, F_{BV})=(70, 50)” as the background frame coordinates information.

The 3D subtitle plane 2820 having the side by side format and stored in the pixel buffer 2870 may be formed of a left-eye subtitle plane 2830 and a right-eye subtitle plane 2840. Horizontal resolutions of the left-eye subtitle plane 2830 and the right-eye subtitle plane 2840 may be reduced by half compared to original resolutions, and if original coordinates of the left-eye subtitle plane 2830 is “(O_{HL}, O_{VL})=(0, 0)”, original coordinates of the right-eye subtitle plane 2840 may be “(O_{HR}, O_{VR})=(100, 0)”.

For example, x-coordinate values of the bitmap and background frame of the left-eye subtitle 2850 may be also each reduced by half. In other words, an x-coordinate value B_{THL} at an upper left point of the bitmap and an x-coordinate value B_{BHL} at a lower right point of the bitmap of the left-eye subtitle 2850, and an x-coordinate value F_{THL} at an upper left point of the frame and an x-coordinate value F_{BHL} at a lower right point of the frame of the left-eye subtitle 2850 may be determined according to Relational Expressions 1 through 4 below.

B_{THL}=B_{TH}/2; (1)

B_{BHL}=B_{BH}/2; (2)

F_{THL}=F_{TH}/2; (3)

F_{BHL}=F_{BH}/2. (4)

Accordingly, the x-coordinate values B_{THL}, B_{BHL}, F_{THL}, and F_{BHL} of the left-eye subtitle 2850 may be determined to be

B_{THL}=B_{TH}/2=30/2=15; (1)

B_{BHL}=B_{BH}/2=60/2=30; (2)

F_{THL}=F_{TH}/2=20/2=10; and (3)

F_{BHL}=F_{BH}/2=70/2=35. (4)

Also, horizontal axis resolutions of the bitmap and the background frame of the right-eye subtitle 2860 may each be reduced by half. X-coordinate values of the bitmap and the background frame of the right-eye subtitle 2860 may be determined based on the original point (O_{HR}, O_{VR}) of the right-eye subtitle plane 2840. Accordingly, an x-coordinate value B_{THR} at an upper left point of the bitmap and an x-coordinate value B_{BHR} at a lower right point of the bitmap of the right-eye subtitle 2860, and an x-coordinate value F_{THR} at an upper left point of the frame and an x-coordinate value F_{BHR} at a lower right point of the frame of the right-eye subtitle 2860 are determined according to Relational Expressions 5 through 8 below.

B_{THR}=O_{HR}+B_{THL}±(3d_subtitle_offset/2); (5)

B_{BHR}=O_{HR}+B_{BHL}±(3d_subtitle_offset/2); (6)

F_{THR}=O_{HR}+F_{THL}±(3d_subtitle_offset/2); (7)

F_{BHR}=O_{HR}+F_{BHL}±(3d_subtitle_offset/2). (8)

In other words, the x-coordinate values of the bitmap and background frames of the right-eye subtitle 2860 may be set by moving the x-coordinates in a negative or positive direction by the offset value of the 3D subtitle from a location moved in a positive direction by an x-coordinate of the left-eye subtitle 2850, based on the original point (O_{HR}, O_{VR}) of the right-eye subtitle plane 2840. For example, where the offset direction of the 3D subtitle is “1”, e.g., “3d_subtitle_direction=1”, the offset direction of the 3D subtitle may be negative.

Accordingly, the x-coordinate values B_{THL}, B_{BHL}, F_{THL}, and F_{BHL} of the bitmap and the background frame of the right-eye subtitle 2860 may be determined to be:

B_{THR}=O_{HR}+B_{THL}−(3d_subtitle_offset/2)=100+15−5=110; (5)

B_{BHR}=O_{HR}+B_{BHL}−(3d_subtitle_offset/2)=100+30−5=125; (6)

F_{THR}=O_{HR}+F_{THL}−(3d_subtitle_offset/2)=100+10−5=105; (7)

F_{BHR}=O_{HR}+F_{BHL}−(3d_subtitle_offset/2)=100+35−5=130. (8)

Accordingly, a display device may reproduce the 3D subtitle in 3D by using the 3D subtitle displayed at a location moved by the offset value in an x-axis direction on the left-eye subtitle plane 2830 and the right-eye subtitle plane 2840.

Also, the program encoder 110 may newly define a descriptor and a subtitle type for defining the depth of a subtitle, and insert the descriptor and the subtitle type into a PES packet.

Table 30 shows a syntax of a “subtitle_depth_descriptor( )” field newly defined by the program encoder 110.

TABLE 30
Syntax

Subtitling_depth_descriptor( ){

descriptor_tag
descriptor_length
reserved (or offset_based)
character_offset_direction
character_offset
reserved
frame_offset_direction
frame_offset

}

The “subtitle_depth_descriptor( )” field may include information about an offset direction of a character (“character_offset_direction”), offset information of the character (“character_offset”), information about an offset direction of a background frame (“frame_offset_direction”), and offset information of the background frame (“frame_offset”).

The “subtitle_depth_descriptor( )” field may selectively include information (“offset_based”) indicating whether an offset value of the character or the background frame is set based on a zero plane or based on offset information of a video image.

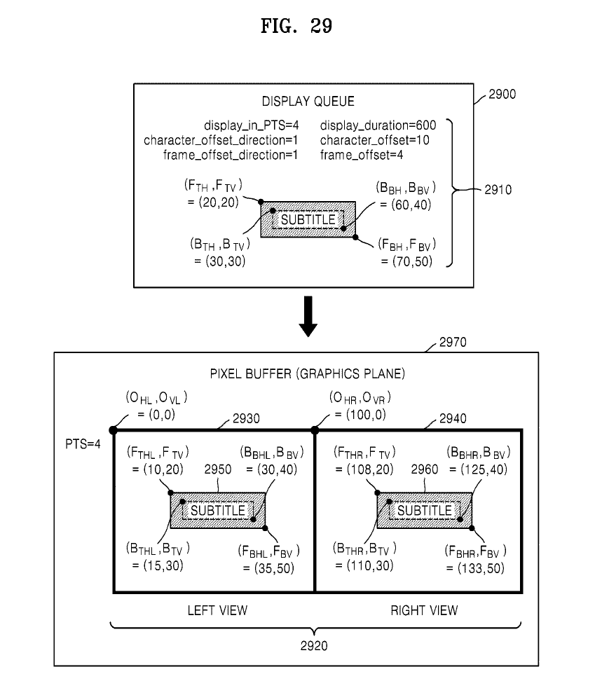

FIG. 29 is a diagram for describing adjusting of depth of a subtitle complying with a cable broadcasting method, according to another embodiment.

The apparatus 200 according to an embodiment may extract information related to bitmap coordinates of the subtitle, information related to frame coordinates of the subtitle, and bitmap data from the bitmap field of Table 28, and may extract information related to reproduction time of the subtitle from the subtitle message table of Table 29. Also, the apparatus 200 may extract information about offset information of a character (“character_offset_direction”) of the subtitle, offset information of the character (“character_offset”), information about an offset direction of a background (“frame_offset_direction”) of the subtitle, and offset information of the background (“frame_offset”) from the subtitle depth descriptor field of Table 30.

Accordingly, a subtitle information set 2910, which may include information related to subtitle reproduction including the information related to reproduction time of the subtitle (display_in_PTS and display_duration), the offset direction of the character (character_offset_direction), the offset information of the character (character_offset), the offset direction of the background frame (frame_offset_direction), and the offset information of the background frame (frame_offset), and subtitle data, may be stored in a display queue 2900.

For example, the display queue 2900 may store “display_in_PTS=4” and “display_duration=600” as the information related to the reproduction time of the subtitle, “character_offset_direction=1” as the offset direction of the character, “character_offset=10” as the offset information of the character, “frame_offset_direction=1” as the offset direction of the background frame, “frame_offset=4” as the offset information of the background frame, “(B_{TH}, B_{TV})=(30, 30)” and “(B_{BH}, B_{BV})=(60, 40)” as bitmap coordinates of the subtitle, and “(F_{TH}, F_{TV})=(20, 20)” and “(F_{BH}, F_{BV})=(70, 50)” as background frame coordinates of the subtitle.

Through operation 2780, it may be presumed that a pixel buffer (graphic plane) 2970 stores a 3D subtitle plane 2920 having a side by side format, which is a 3D composition format.

Similar to FIG. 28, an x-coordinate value B_{THL} at an upper left point of a bitmap, an x-coordinate value B_{BHL} at a lower right point of the bitmap, an x-coordinate value F_{THL} at an upper left point of a frame, and an x-coordinate value F_{BHL} of a lower right point of the frame of a left-eye subtitle 2950 on a left-eye subtitle plane 2930 from among the 3D subtitle plane 2920 stored in the pixel buffer 2970 may be determined to be:

B_{THL}=B_{TH}/2=30/2=15; (9)

B_{BHL}=B_{BH}/2=60/2=30; (10)

F_{THL}=F_{TH}/2=20/2=10; and (11)

F_{BHL}=F_{BH}/2=70/2=35. (12)

Also, an x-coordinate value B_{THR} at an upper left point of a bitmap, an x-coordinate value B_{BHR} at a lower right point of the bitmap, an x-coordinate value F_{THR} at an upper left point of a frame, and an x-coordinate value F_{BHR} of a lower right point of the frame of a right-eye subtitle 2960 on a right-eye subtitle plane 2940 from among the 3D subtitle plane 2920 are determined according to Relational Expressions 13 through 15 below.

B_{THR}=O_{HR}+B_{THL}±(character_offset/2); (13)

B_{BHR}=O_{HR}+B_{BHL}±(character_offset/2); (14)

F_{THR}=O_{HR}+F_{THL}±(frame_offset/2); (15)

F_{BHR}=O_{HR}+F_{BHL}±(frame_offset/2). (16)

For example, where “character_offset_direction=1” and “frame_offset_direction=1”, the offset direction of the 3D subtitle may be negative.

Accordingly, the x-coordinate values B_{THL}, B_{BHL}, F_{THL}, and F_{BHL} of the bitmap and the background frame of the right-eye subtitle 2960 may be determined to be:

B_{THR}=O_{HR}+B_{THL}−(character_offset/2)=100+15−5=110; (13)

B_{BHR}=O_{HR}+B_{BHL}−(character_offset/2)=100+30−5=125; (14)

F_{THR}=O_{HR}+F_{THL}−(frame_offset/2)=100+10−2=108; and (15)

F_{BHR}=O_{HR}+F_{BHL}−(frame_offset/2)=100+35−2=133. (16)

Accordingly, the subtitle may be reproduced in 3D as the left-eye subtitle 2950 and the right-eye subtitle 2960 may be disposed respectively on the left-eye subtitle plane 2930 and the right-eye subtitle plane 2940 after being moved by the offset value in an x-axis direction.

The apparatus 100 according to an embodiment may additionally set a subtitle type for another view to reproduce the subtitle in 3D. Table 31 shows subtitle types modified by the apparatus 100.

TABLE 31

| subtitle_type | Meaning |
|---|---|
| 0 | Reserved |
| 1 | simple_bitmap - Indicates that subtitle data block |
| | contains data formatted in the simple bitmap style |
| 2 | subtitle_another_view - Bitmap and background frame |
| | coordinates of another view for 3D |
| 3-15 | Reserved |

Referring to Table 31, the apparatus 100 may additionally assign the subtitle type for the other view (“subtitle_another_view”) to a subtitle type field value “2”, by using a reversed region, in which a subtitle type field value is in the range from, e.g., 2 to 15, from among the basic table of Table 25.

The apparatus 100 may change the basic subtitle message table of Table 22 based on the modified subtitle types of Table 31. Table 32 shows a syntax of a modified subtitle message table (“subtitle_message( )”).

TABLE 32
Syntax

subtitle_message( ){

table_ID
zero
ISO reserved
section_length
zero
segmentation_overlay_included
protocol_version
if (segmentation_overlay_included) {

table_extension
last_segment_number
segment_number

}
ISO_639_language_code
pre_clear_display
immediate
reserved
display_standard
display_in_PTS
subtitle_type
reserved
display_duration
block_length
if (subtitle_type==simple_bitmap) {

simple_bitmap( )

} else if (subtitle_type==subtitle_another_view)

{

subtitle_another_view( )

} else {

reserved( )

}
for (i=0; i<N; i++) {

descriptor( )

}
CRC_32

}

In other words, in the modified subtitle message table, when the subtitle type is a “subtitle_another_view” field, a “subtitle_another_view( )” field may be additionally included to set another view subtitle information. Table 33 shows a syntax of the “subtitle_another_view( )” field.

TABLE 33
Syntax

subtitle_another_view ( ){

reserved
background_style
outline_style
character_color( )
bitmap_top_H_coordinate
bitmap_top_V_Coordinate
bitmap_bottom_H_coordinate
bitmap_bottom_V_coordinate
if (background_style==framed){

frame_top_H_coordinate
frame_top_V_coordinate
frame_bottom_H_coordinate
frame_bottom_V_coordinate
frame_color( )

}
if (outline_style==outlined){

reserved
outline_thickness
outline_color( )

} else if (outline_style==drop_shadow){

shadow_right
shadow_bottom
shadow_color( )

} else if (outline_style==reserved){

reserved

}
bitmap_length
compressed_bitmap( )

}

The “subtitle_another_view( )” field may include information about coordinates of a bitmap of the subtitle for the other view (bitmap_top_H_coordinate, bitmap_top_V_coordinate, bitmap_bottom_H_coordinate, bitmap_bottom_V_coordinate). Also, if a background frame of the subtitle for the other view exists based on a “background_style” field, the “subtitle_another_view( )” field may include information about coordinates of the background frame of the subtitle for the other view (frame_top_H_coordinate, frame_top_V_coordinate, frame_bottom_H_coordinate, frame_bottom_V_coordinate).

The apparatus 100 may not only include the information about the coordinates of the bitmap and the background frame of the subtitle for the other view, but may also include thickness information (outline_thickness) of an outline if the outline exists, and thickness information of right and left shadows (shadow_right and shadow_bottom) of a drop shadow if the drop shadow exists, in the “subtitle_another_view( )” field.

The apparatus 200 may generate a subtitle of a reference view and a subtitle of another view by using the “subtitle_another_view( )” field.

Alternatively, the apparatus 200 may extract and use only the information about the coordinates of the bitmap and the background frame of the subtitle from the “subtitle_another_view( )” field to reduce data throughput.

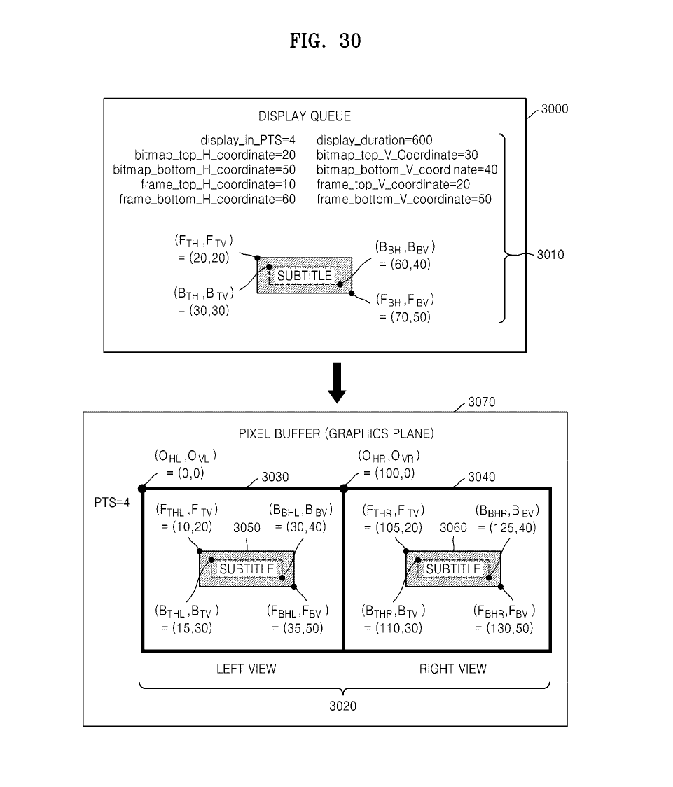

FIG. 30 is a diagram for describing adjusting of the depth of a subtitle complying with a cable broadcasting method, according to another embodiment.

The apparatus 200 according to an embodiment may extract information about the reproduction time of the subtitle from the subtitle message table of Table 32 that is modified to consider the “subtitle_another_view( )” field, and may extract the information about the coordinates of the bitmap and background frame of the subtitle for another view, and the bitmap data from the “subtitle_another_view( )” field of Table 33.

Accordingly, a display queue 3000 may store a subtitle information set 3010, which may include subtitle data and information related to subtitle reproduction including information related to a reproduction time of a subtitle (display_in_PTS and display_duration), information about coordinates of a bitmap of a subtitle for another view (bitmap_top_H_coordinate, bitmap_top_V_coordinate, bitmap_bottom_H coordinate, and bitmap_bottom_V_coordinate), and information about coordinates of a background frame of the subtitle for the other view (frame_top_H_coordinate, frame_top_V_coordinate, frame_bottom_H_coordinate, and frame_bottom_V coordinate.

For example, it may be presumed that the display queue 3000 includes the information related to the subtitle reproduction including “display_in_PTS=4” and “display_duration=600” as information related to reproduction time of the subtitle, “bitmap_top_H_coordinate=20”, “bitmap_top_V_coordinate=30”, “bitmap_bottom_H_coordinate=50”, and “bitmap_bottom_V_coordinate=40” as the information about the coordinates of the bitmap of the subtitle for the other view, and “frame_top_H_coordinate=10”, “frame_top_V_coordinate=20”, “frame_bottom_H_coordinate=60”, and “frame_bottom_V_coordinate=50” as the information about the coordinates of the background frame of the subtitle for the other view, “(B_{TH}, B_{TV})=(30, 30)” and “(B_{BH}, B_{BV})=(60, 40)” as information about coordinates of bitmap of a subtitle, and “(F_{TH}, F_{TV})=(20, 20)” and “(F_{BH}, F_{BV})=(70, 50)” as information about coordinates of a background frame of the subtitle.

Through operation 2780 of FIG. 27, it may be presumed that a 3D subtitle plane 3020 having a side by side format, which is a 3D composition format, is stored in a pixel buffer (graphic plane) 3070. Similar to FIG. 32, an x-coordinate value B_{THL} at an upper left point of a bitmap, an x-coordinate value B_{BHL} at a lower right point of the bitmap, an x-coordinate value F_{THL} at an upper left point of a frame, and an x-coordinate value F_{BHL} of a lower right point of the frame of a left-eye subtitle 3050 on a left-eye subtitle plane 3030 from among the 3D subtitle plane 3020 stored in the pixel buffer 3070 may be determined to be:

B_{THL}=B_{TH}/2=30/2=15; (17)

B_{BHL}=B_{BH}/2=60/2=30; (18)

F_{THL}=F_{TH}/2=20/2=10; and (19)

F_{BHL}=F_{BH}/2=70/2=35. (20)

Also, an x-coordinate value B_{THR} at an upper left point of a bitmap, an x-coordinate value B_{BHR} at a lower right point of the bitmap, an x-coordinate value F_{THR} at an upper left point of a frame, and an x-coordinate value F_{BHR} of a lower right point of the frame of a right-eye subtitle 3060 on a right-eye subtitle plane 3040 from among the 3D subtitle plane 3020 may be determined according to Relational Expressions 21 through 24 below.

B_{THR}=O_{HR}+bitmap_top_H_coordinate/2; (21)

B_{BHR}=O_{HR}+bitmap_bottom_H_coordinate/2; (22)

F_{THR}=O_{HR}+frame_top_H_coordinate/2; (23)

F_{BHR}=O_{HR}+frame_bottom_H_coordinate/2. (24)

Accordingly, the x-coordinate values B_{THL}, B_{BHL}, F_{THL}, and F_{BHL} of the right-eye subtitle 3060 may be determined to be:

B_{THR}=O_{HR}+bitmap_top_H_coordinate/2=100+10=110; (21)

B_{BHR}=O_{HR}+bitmap_bottom_H_coordinate/2=100+25=125; (22)

F_{THR}=O_{HR}+frame_top_H_coordinate/2=100+5=105; and (23)

F_{BHR}=O_{HR}+frame_bottom_H_coordinate/2=100+30=130. (24)

Accordingly, the subtitle may be reproduced in 3D as the left-eye subtitle 3050 and the right-eye subtitle 3060 may be disposed respectively on the left-eye subtitle plane 3030 and the right-eye subtitle plane 3040 after being moved by the offset value to an x-axis direction.

The apparatus 100 according to an embodiment may additionally set a subtitle disparity type of the subtitle as a subtitle type to give a 3D effect to the subtitle. Table 34 shows subtitle types modified to add the subtitle disparity type by the apparatus 100.

TABLE 34

| subtitle_type | Meaning |
|---|---|
| 0 | Reserved |
| 1 | simple_bitmap - Indicates that subtitle data block |
| | contains data formatted in the simple bitmap style |
| 2 | subtitle_disparity - Disparity information for 3D |
| | effect |
| 3-15 | Reserved |

According to Table 34, the apparatus 100 according to an embodiment may additionally set the subtitle disparity type (“subtitle_disparity”) to a subtitle type field value “2”, by using a reserved region from the basic table of the subtitle type of Table 25.

The apparatus 100 may newly set a subtitle disparity field based on the modified subtitle types of Table 34. Table 35 shows a syntax of the “subtitle_disparity( )” field, according to an embodiment.

TABLE 35
Syntax

subtitle_disparity( ){

disparity

}

According to Table 35, the subtitle disparity field may include a “disparity” field including disparity information between a left-eye subtitle and a right-eye subtitle.

The apparatus 200 may extract information related to a reproduction time of a subtitle from the subtitle message table modified to consider the newly set “subtitle_disparity” field, and extract disparity information and bitmap data of the subtitle from the “subtitle_disparity” field of Table 35. Accordingly, the reproducer 240 according to an embodiment may reproduce the subtitle in 3D by displaying the right-eye subtitle and the left-eye subtitle at locations that are moved by the disparity.

As such, according to embodiments, a subtitle may be reproduced in 3D with a video image by using 3D reproduction information.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing a signal, the method comprising:
extracting three-dimensional (3D) reproduction information for reproducing a subtitle, the subtitle being reproduced with a video image, in 3D, from additional data for generating the subtitle; and
reproducing the subtitle in 3D by using the additional data and the 3D reproduction information.

2. The method of claim 1, wherein the 3D reproduction information comprises offset information comprising at least one of: a movement value, a depth value, a disparity, and parallax of a region where the subtitle is displayed.

3. The method of claim 2, wherein the 3D reproduction information further comprises an offset direction indicating a direction in which the offset information is applied.

4. The method of claim 3, wherein the reproducing of the subtitle in 3D comprises adjusting a location of the region where the subtitle is displayed by using the offset information and the offset direction.

5. The method of claim 4, wherein:
the additional data comprises text subtitle data; and
the extracting of the 3D reproduction information comprises extracting the 3D reproduction information from a dialog presentation segment included in the text subtitle data.

6. The method of claim 5, wherein the dialog presentation segment comprises:
a number of the regions where the subtitle is displayed; and
a number of pieces of offset information equaling the number_of_regions where the subtitle is displayed.

7. The method of claim 5, wherein the adjusting of the location comprises:
extracting dialog region location information from a dialog style segment included in the text subtitle data; and
adjusting the location of the region where the subtitle is displayed by using the dialog region location information, the offset information, and the offset direction.

8. The method of claim 4, wherein:
the additional data comprises subtitle data;
the subtitle data comprises a composition page;
the composition page comprises a page composition segment; and
the extracting of the 3D reproduction information comprises extracting the 3D reproduction information from the page composition segment.

9. The method of claim 4, wherein:
the additional data comprises subtitle data;
the subtitle data comprises a composition page;
the composition page comprises a depth definition segment; and
the extracting of the 3D reproduction information comprises extracting the 3D reproduction information from the depth definition segment.

10. The method of claim 8, wherein the 3D reproduction information further comprises information about whether the 3D reproduction information is generated, based on offset information of the video image or based on a screen having zero (0) disparity.

11. The method of claim 8, wherein the extracting of the 3D reproduction information comprises extracting at least one of: offset information according to pages and offset information according to regions in a page.

12. The method of claim 4, wherein:
the additional data comprises a subtitle message; and
the extracting of the 3D reproduction information comprises extracting the 3D reproduction information from the subtitle message.

13. The method of claim 12, wherein:
the subtitle message comprises simple bitmap information; and
the extracting of the 3D reproduction information comprises extracting the 3D reproduction information form the simple bitmap information.

14. The method of claim 13, wherein the extracting of the 3D reproduction information comprises:
extracting the offset information from the simple bitmap information; and
extracting the offset direction from the subtitle message.

15. The method of claim 12, wherein:
the subtitle message further comprises a descriptor defining the 3D reproduction information; and
the extracting of the 3D reproduction information comprises extracting the 3D reproduction information from the descriptor included in the subtitle message.

16. The method of claim 15, wherein the descriptor comprises:
offset information about at least one of: a character and a frame; and
the offset direction.

17. The method of claim 12, wherein:
the subtitle message further comprises a subtitle type; and
in response to the subtitle type indicating another view subtitle, the subtitle message further comprises information about the other view subtitle.

18. The method of claim 17, wherein the information about the other view subtitle comprises frame coordinates of the other view subtitle.

19. The method of claim 17, wherein the information about the other view subtitle comprises disparity information of the other view subtitle with respect to a reference view subtitle.

20. The method of claim 17, wherein the information about the other view subtitle comprises information about a subtitle bitmap for generating the other view subtitle.

21. The method of claim 9, wherein the 3D reproduction information further comprises information about whether the 3D reproduction information is generated based on:
offset information of the video image; or
a screen having zero (0) disparity.

22. The method of claim 9, wherein the extracting of the 3D reproduction information comprises extracting at least one of:
offset information according to pages; and
offset information according to regions in a page.

23. An apparatus for processing a signal, the apparatus comprising:
a subtitle decoder configured to extract three-dimensional (3D) reproduction information to:
reproduce a subtitle, the subtitle being reproduced with a video image, in 3D, from additional data for generating the subtitle; and
reproduce the subtitle in 3D by using the additional data and the 3D reproduction information.

24. The apparatus of claim 23, wherein the 3D reproduction information comprises offset information comprising at least one of: a movement value, a depth value, a disparity, and parallax of a region where the subtitle is displayed.

25. The apparatus of claim 24, wherein the 3D reproduction information further comprises an offset direction indicating a direction in which the offset information is applied.

26. The apparatus of claim 25, wherein the subtitle decoder is further configured to adjust a location of the region where the subtitle is displayed by using the offset information and the offset direction.

27. The apparatus of claim 26, wherein:
the additional data comprises text subtitle data; and
the apparatus further comprises a dialog presentation controller configured to extract the 3D reproduction information from a dialog presentation segment included in the text subtitle data.

28. The apparatus of claim 27, wherein the dialog presentation segment comprises:
a number of the regions where the subtitle is displayed; and
a number of pieces of offset information equaling the number_of_regions where the subtitle is displayed.

29. The apparatus of claim 27, wherein the dialog presentation controller is further configured to:
extract dialog region location information from a dialog style segment included in the text subtitle data; and
adjust the location of the region where the subtitle is displayed by using the dialog region location information, the offset information, and the offset direction.

30. The apparatus of claim 26, wherein:
the additional data comprises subtitle data;
the subtitle data comprises a composition page;
the composition page comprises a page composition segment;
the apparatus further comprises a composition buffer; and
the subtitle decoder is further configured to store the 3D reproduction information extracted from the page composition segment in the composition buffer.

31. The apparatus of claim 26, wherein:
the additional data comprises subtitle data;
the subtitle data comprises a composition page;
the composition page comprises a depth definition segment;
the apparatus further comprises a composition buffer; and
the subtitle decoder is further configured to store the 3D reproduction information included in the depth definition segment, in the composition buffer.

32. The apparatus of claim 30, wherein the 3D reproduction information further comprises information about whether the 3D reproduction information is generated based on offset information of the video image or based on a screen having zero (0) disparity.

33. The apparatus of claim 30, wherein the extracting of the 3D reproduction information comprises extracting at least one of: offset information according to pages and offset information according to regions in a page.

34. The apparatus of claim 26, wherein:
the additional data comprises a subtitle message; and
the subtitle decoder is further configured to extract the 3D reproduction information from the subtitle message.

35. The apparatus of claim 34, wherein:
the subtitle message comprises simple bitmap information; and
the subtitle decoder is further configured to extract the 3D reproduction information from the simple bitmap information.

36. The apparatus of claim 35, wherein the subtitle decoder is further configured to:
extract the offset information from the simple bitmap information; and
extract the offset direction from the subtitle message.

37. The apparatus of claim 34, wherein:
the subtitle message further comprises a descriptor defining the 3D reproduction information; and
the subtitle decoder is further configured to extract the 3D reproduction information from the descriptor included in the subtitle message.

38. The apparatus of claim 37, wherein the descriptor comprises offset information about:
at least one of: a character and a frame; and
the offset direction.

39. The apparatus of claim 34, wherein:
the subtitle message further comprises a subtitle type; and
in response to the subtitle type indicating another view subtitle, the subtitle message further comprises information about the other view subtitle.

40. The apparatus of claim 39, wherein the information about the other view subtitle comprises frame coordinates of the other view subtitle.

41. The apparatus of claim 39, wherein the information about the other view subtitle comprises disparity information of the other view subtitle with respect to a reference view subtitle.

42. The apparatus of claim 39, wherein the information about the other view subtitle comprises information about a subtitle bitmap for generating the other view subtitle.

43. The apparatus of claim 31, wherein the 3D reproduction information further comprises information about whether the 3D reproduction information is generated based on offset information of the video image or based on a screen having zero (0) disparity.

44. The apparatus of claim 31, wherein the 3D reproduction information comprises at least one of:
offset information according to pages; and
offset information according to regions in a page.

45. A computer-readable recording medium having recorded thereon additional data for generating a subtitle that is reproduced with a video image, the additional data comprising text subtitle data, the text subtitle data comprising a dialog style segment and a dialog presentation segment, the dialog presentation segment comprising three-dimensional (3D) reproduction information for reproducing the subtitle in 3D.

46. A computer-readable recording medium having recorded thereon additional data for generating a subtitle that is reproduced with a video image, the additional data comprising subtitle data, the subtitle data comprising a composition page, the composition page comprising a page composition segment, the page composition segment comprising three-dimensional (3D) reproduction information for reproducing the subtitle in 3D.

47. A computer-readable recording medium having recorded thereon additional data for generating a subtitle that is reproduced with a video image, the additional data comprising subtitle data, the subtitle data comprising a subtitle message, and the subtitle message comprising three-dimensional (3D) reproduction information for reproducing the subtitle in 3D.
